(19) United States
(12) Patent Application Publication
(10) Pub. No.: US 2026/0122353 A1
(43) Pub. Date: Apr. 30, 2026

(54) REFLECTION MODULE AND CAMERA MODULE INCLUDING THE SAME

(71) Applicant: SAMSUNG ELECTRO-MECHANICS CO., LTD., Suwon-si (KR)

(72) Inventors: Young Hwan KWON, Suwon-si (KR); Jae Hyung HAN, Suwon-si (KR); Young Bok YOON, Suwon-si (KR); Soo Cheol LIM, Suwon-si (KR); Sang Uk SON, Suwon-si (KR); Won Kyu JEUNG, Suwon-si (KR)

(73) Assignee: SAMSUNG ELECTRO-MECHANICS CO., LTD., Suwon-si (KR)

(21) Appl. No.: 19/366,767

(22) Filed: Oct. 23, 2025

(30) Foreign Application Priority Data
Oct. 29, 2024 (KR) 10-2024-0150101
Sep. 30, 2025 (KR) 10-2025-0142978

(51) Int. Cl. H04N 23/68; H04N 23/51; H04N 23/54

(52) U.S. Cl. CPC H04N 23/687; H04N 23/51; H04N 23/54

(57) ABSTRACT

A reflection module is provided. The reflection module includes a housing; a guide member configured to rotate relative to the housing, based on a first rotation axis; a holder configured to rotate relative to the guide member based on a second rotation axis, and having a reflection member mounted thereon; a first pulling member disposed between the guide member and the holder; and a first magnetic member and a second magnetic member spaced apart from each other in a direction of the first rotation axis, with the first pulling member interposed between the first magnetic member and the second magnetic member, and the first magnetic member may include a first magnet disposed on the guide member, and the second magnetic member may include a second magnet disposed on the guide member.

### CROSS-REFERENCE TO RELATED APPLICATIONS

This application claims the benefit under 35 USC § 119(a) of Korean Patent Application No. 10-2024-0150101 filed on Oct. 29, 2024, and Korean Patent Application No. 10-2025-0142978 filed on Sep. 30, 2025, in the Korean Intellectual Property Office, the entire disclosures of which are incorporated herein by reference for all purposes.

### BACKGROUND

### 1. Field

The following description relates to a reflection module and a camera module including the same.

### 2. Description of Related Art

Recent mobile devices may include camera modules that bend a path of light by disposing a reflection element in front of a lens module.

Additionally, camera modules may feature image stabilization operations to compensate for camera shake during image capture operations to improve resolution. This image stabilization may be achieved through the two-axis rotation of the reflection element.

In this example, because the reflection element may be disposed in a rotatable state, the reflection element may tilt to one side when the camera module is turned off.

Additionally, a plurality of drivers may be needed for two-axis rotation of the reflection member, and the structure of the plurality of drivers may be complicated, which may result in increased size and weight.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In a general aspect, a reflection module includes a housing; a guide member configured to rotate relative to the housing, based on a first rotation axis; a holder, configured to rotate relative to the guide member based on a second rotation axis, and having a reflection member mounted thereon; a first pulling member disposed between the guide member and the holder; and a first magnetic member and a second magnetic member spaced apart from each other in a direction of the first rotation axis, with the first pulling member interposed between the first magnetic member and the second magnetic member, wherein the first magnetic member includes a first magnet disposed on the guide member, and wherein the second magnetic member includes a second magnet disposed on the guide member.

The first pulling member may include a first pulling magnet disposed in one of the guide member and the holder and a first pulling yoke disposed in another of the guide member and the holder, and the first pulling magnet and the first pulling yoke may face each other in a direction, perpendicular to both the first rotation axis and the second rotation axis.

One surface of the first magnet and one surface of the second magnet, which are exposed to an external surface of the guide member, may each have a single polarity.

The first magnetic member may further include a third magnet disposed on the holder, and the second magnetic member may include a fourth magnet disposed on the holder.

Surfaces on which the first magnet and the third magnet face each other may have a same polarity, and surfaces on which the second magnet and the fourth magnet face each other may have a same polarity.

A direction of a magnetic force of the first pulling member and a direction of a magnetic force of the first magnetic member may be opposite to each other, and a direction of a magnetic force of the first pulling member and a direction of a magnetic force of the second magnetic member may be opposite to each other.

A first ball member may be disposed between the guide member and the holder, and the first ball member may include a plurality of balls spaced apart from each other in a direction of the second rotation axis.

The first pulling member may be disposed between the plurality of balls.

The second rotation axis may be disposed between the first magnetic member and the second magnetic member.

The reflection module may further include a first diver including a driving magnet unit disposed in the holder and a coil unit that faces the driving magnet unit, wherein the driving magnet unit may include a first driving magnet and a second driving magnet that are spaced apart from each other in the direction of the first rotation axis.

A first ball member may be disposed between the guide member and the holder, and the first ball member may include a plurality of balls that are spaced apart from each other in a direction of the second rotation axis, a second ball member may be disposed between the guide member and the housing, and the second ball member may include a plurality of balls that are spaced apart from each other in the direction of the first rotation axis, wherein the first driver may be spaced apart from the second ball member in the direction of the second rotation axis, and wherein the first driver may be spaced apart from the first ball member in the direction of the first rotation axis.

The reflection module may further include a position sensing unit including a plurality of first position sensors disposed in the housing, wherein the plurality of first position sensors may be spaced apart from each other in the direction of the first rotation axis.

The position sensing unit may further include a plurality of sensing magnets disposed on the holder, and the plurality of sensing magnets are spaced apart from each other in the direction of the first rotation axis.

The position sensing unit may be configured to: generate a first position signal of the holder by summing signal values output from the plurality of first position sensors, and generate a second position signal of the holder by calculating a difference between signal values output from the plurality of first position sensors, wherein the first position signal is a position signal of one of a rotation of the holder based on the first rotation axis and a rotation of the holder based on the second rotation axis, and wherein the second position signal may be a position signal of another of a rotation of the holder based on the first rotation axis and a rotation of the holder based on the second rotation axis.

The reflection module may further include a first lens module having a first optical axis and coupled to the holder, wherein the first rotation axis and the second rotation axis are perpendicular to each other, and wherein the first optical axis is perpendicular to both the first rotation axis and the second rotation axis.

In a general aspect, a camera module includes a housing; a guide member configured to rotate relative to the housing based on a first rotation axis; a holder, configured to rotate relative to the guide member based on a second rotation axis, and having a reflection member mounted thereon; a first magnetic member and a second magnetic member spaced apart from each other in a direction of the first rotation axis; a first driver comprising a driving magnet unit disposed in the holder and a coil unit that faces the driving magnet unit; a first ball member disposed between the guide member and the holder, and comprising a plurality of balls spaced apart from each other in a direction of the second rotation axis; and a second ball member disposed between the guide member and the housing, and including a plurality of balls spaced apart from each other in the direction of the first rotation axis, wherein the driving magnet unit comprises a first driving magnet and a second driving magnet spaced apart from each other in the direction of the first rotation axis, wherein the first magnetic member comprises a first magnet disposed in the guide member, wherein the second magnetic member comprises a second magnet disposed on the guide member, and wherein a first ball member is disposed between the first magnet and the second magnet.

The camera module may further include a first pulling member disposed between the guide member and the holder, wherein the first pulling member is disposed between the plurality of balls of the first ball member.

The first pulling member may include a first pulling magnet disposed in one of the guide member and the holder, and a first pulling yoke disposed in another of the guide member and the holder, wherein one surface of the first pulling magnet facing the first pulling yoke has a plurality of polarities, and wherein one surface of the first magnet and one surface of the second magnet facing the holder each have a single polarity.

A gap between the first pulling magnet and the first pulling yoke may be narrower than a gap between the first magnet and the holder, and narrower than a gap between the second magnet and the holder.

The coil unit may include a first coil that faces a first surface of the first driving magnet and a second coil that faces a first surface of the second driving magnet, wherein each of the first surface of the first driving magnet and the first surface of the second driving magnet is polarized to have different polarities in directions perpendicular to both the first rotation axis and the second rotation axis, wherein a second surface of the first driving magnet has a polarity opposite to the first surface of the first driving magnet, and a second surface of the second driving magnet has a polarity opposite to the first surface of the second driving magnet, wherein a first surface of the first magnet may have a same polarity as one of polarities of a second surface of the first driving magnet, and wherein a first surface of the second magnet may have a same polarity as one of polarities of a second surface of the second driving magnet.

Other features and aspects will be apparent from the following detailed description, the drawings, and the claims.

### BRIEF DESCRIPTION OF DRAWINGS

FIG. 1 illustrates a perspective view of an example camera module, in accordance with one or more embodiments.

FIG. 2 and FIG. 3 are partially cutaway perspective views of an example camera module, in accordance with one or more embodiments.

FIG. 4 illustrates an exploded perspective view of an example camera module, in accordance with one or more embodiments.

FIG. 5 illustrates an exploded perspective view of a reflection module and a housing, in accordance with one or more embodiments.

FIG. 6 illustrates a bottom perspective view of a guide member of a reflection module, in accordance with one or more embodiments.

FIG. 7 illustrates a partially exploded perspective view of a reflection module.

FIG. 8 illustrates a plan view of a guide member.

FIG. 9 illustrates a bottom view of a guide member.

FIG. 10 illustrates a plan view of a holder and a reflection member.

FIG. 11 illustrates a bottom view of a holder.

FIG. 12 illustrates a schematic cross-sectional view of a first magnetic member, a second magnetic member and a second pulling member, in accordance with one or more embodiments.

FIG. 13 and FIG. 14 illustrate an attractive force and repulsive force acting between the guide member and the holder.

FIG. 15 illustrates a perspective view of a reflection module and a first lens module, in accordance with one or more embodiments.

FIG. 16 illustrates a view illustrating a modified example of FIG. 15.

FIG. 17 illustrates a block diagram illustrating a configuration of a first driver and a position sensing unit, in accordance with one or more embodiments.

FIG. 18 illustrates a perspective view of a first driver, a first ball member, and a second ball member, in accordance with one or more embodiments.

FIG. 19 illustrates a plan view of a housing, in accordance with one or more embodiments.

FIG. 20 illustrates a perspective view illustrating a second lens module separated from a camera module, in accordance with one or more embodiments.

FIG. 21 illustrates a bottom perspective view of a second lens module;

FIGS. 22 to 25 illustrate a modified example of first and second magnetic members of a reflection module.

FIG. 26 illustrates an exploded perspective view of an example camera module, in accordance with one or more embodiments.

Throughout the drawings and the detailed description, unless otherwise described, the same reference numerals refer to the same elements. The drawings may not be to scale, and the relative size, proportions, and depiction of elements in the drawings may be exaggerated for clarity, illustration, and convenience.

### DETAILED DESCRIPTION

The following detailed description is provided to assist the reader in gaining a comprehensive understanding of the methods, apparatuses, and/or systems described herein. However, various changes, modifications, and equivalents of the methods, apparatuses, and/or systems described herein will be apparent after an understanding of the disclosure of this application. For example, the sequences within and/or of operations described herein are merely examples, and are not limited to those set forth herein, but may be changed as will be apparent after an understanding of the disclosure of this application, except for sequences within and/or of operations necessarily occurring in a certain order. As another example, the sequences of and/or within operations may be performed in parallel, except for at least a portion of sequences of and/or within operations necessarily occurring in an order, e.g., a certain order. Also, descriptions of features that are known after an understanding of the disclosure of this application may be omitted for increased clarity and conciseness.

Although terms such as “first,” “second,” and “third”, or A, B, (a), (b), and the like may be used herein to describe various members, components, regions, layers, or sections, these members, components, regions, layers, or sections are not to be limited by these terms. Each of these terminologies is not used to define an essence, order, or sequence of corresponding members, components, regions, layers, or sections, for example, but used merely to distinguish the corresponding members, components, regions, layers, or sections from other members, components, regions, layers, or sections. Thus, a first member, component, region, layer, or section referred to in the examples described herein may also be referred to as a second member, component, region, layer, or section without departing from the teachings of the examples.

Throughout the specification, when a component or element is described as “on,” “connected to,” “coupled to,” or “joined to” another component, element, or layer, it may be directly (e.g., in contact with the other component, element, or layer) “on,” “connected to,” “coupled to,” or “joined to” the other component element, or layer, or there may reasonably be one or more other components elements, or layers intervening therebetween. When a component or element is described as “directly on”, “directly connected to,” “directly coupled to,” or “directly joined to” another component element, or layer, there can be no other components, elements, or layers intervening therebetween. Likewise, expressions, for example, “between” and “immediately between” and “adjacent to” and “immediately adjacent to” may also be construed as described in the foregoing.

The terminology used herein is for describing various examples only and is not to be used to limit the disclosure. The articles “a,” “an,” and “the” are intended to include the plural forms as well, unless the context clearly indicates otherwise. As non-limiting examples, terms “comprise” or “comprises,” “include” or “includes,” and “have” or “has” specify the presence of stated features, numbers, operations, members, elements, and/or combinations thereof, but do not preclude the presence or addition of one or more other features, numbers, operations, members, elements, and/or combinations thereof, or the alternate presence of an alternative stated features, numbers, operations, members, elements, and/or combinations thereof. Additionally, while one embodiment may set forth such terms “comprise” or “comprises,” “include” or “includes,” and “have” or “has” specify the presence of stated features, numbers, operations, members, elements, and/or combinations thereof, other embodiments may exist where one or more of the stated features, numbers, operations, members, elements, and/or combinations thereof are not present.

As used herein, the term “and/or” includes any one and any combination of any two or more of the associated listed items. The phrases “at least one of A, B, and C”, “at least one of A, B, or C”, and the like are intended to have disjunctive meanings, and these phrases “at least one of A, B, and C”, “at least one of A, B, or C”, and the like also include examples where there may be one or more of each of A, B, and/or C (e.g., any combination of one or more of each of A, B, and C), unless the corresponding description and embodiment necessitates such listings (e.g., “at least one of A, B, and C”) to be interpreted to have a conjunctive meaning.

The features described herein may be embodied in different forms, and are not to be construed as being limited to the examples described herein. Rather, the examples described herein have been provided merely to illustrate some of the many possible ways of implementing the methods, apparatuses, and/or systems described herein that will be apparent after an understanding of the disclosure of this application. The use of the term “may” herein with respect to an example or embodiment (e.g., as to what an example or embodiment may include or implement) means that at least one example or embodiment exists where such a feature is included or implemented, while all examples are not limited thereto. The use of the terms “example” or “embodiment” herein have a same meaning (e.g., the phrasing “in one example” has a same meaning as “in one embodiment”, and “one or more examples” has a same meaning as “in one or more embodiments”).

The one or more examples relate to a reflection module, and a camera module including the same, and the camera module may be mounted on a portable electronic device such as, but not limited to, a mobile communication terminal, a smart phone, or a tablet personal computer (PC).

One or more examples may provide a reflection module and a camera module including the same, which enable a reflection member to be disposed in an original position thereof in a state in which no power is applied.

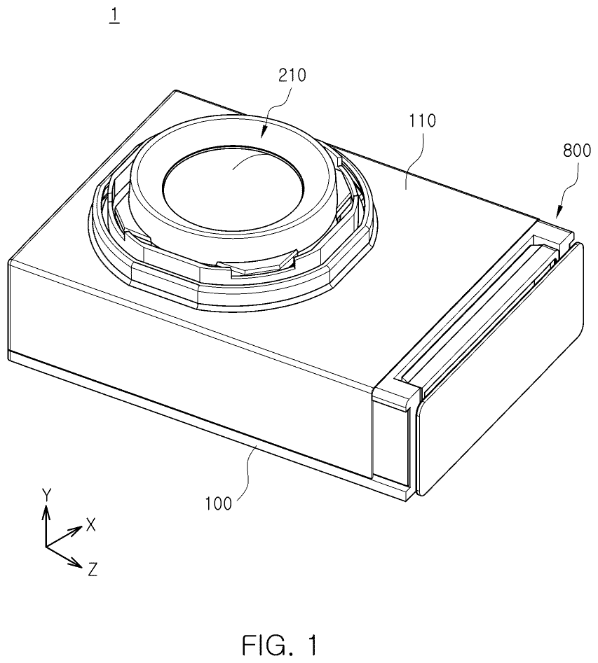

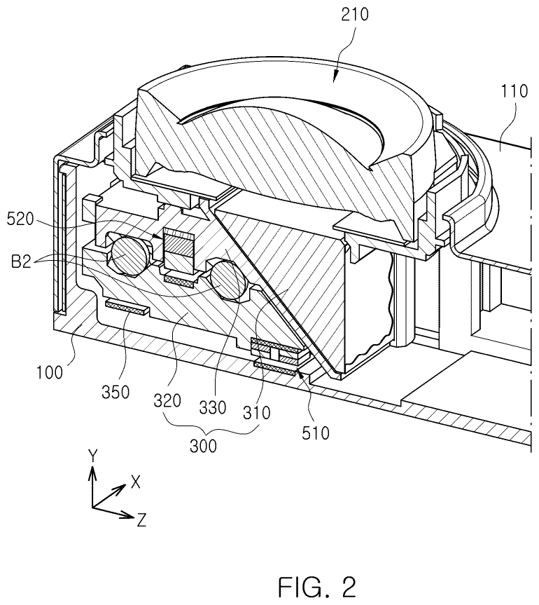

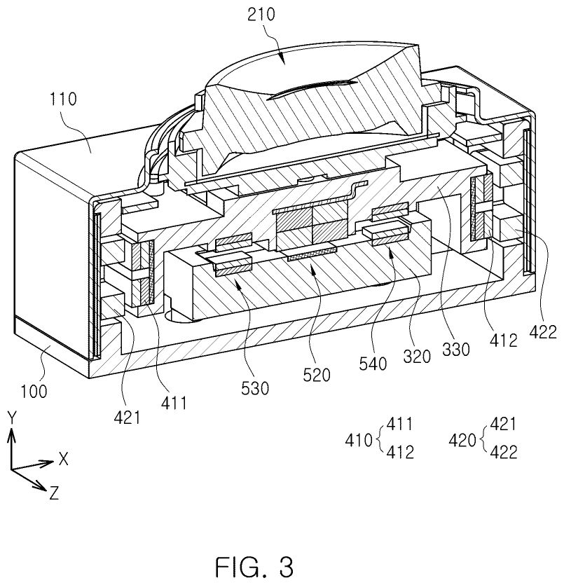

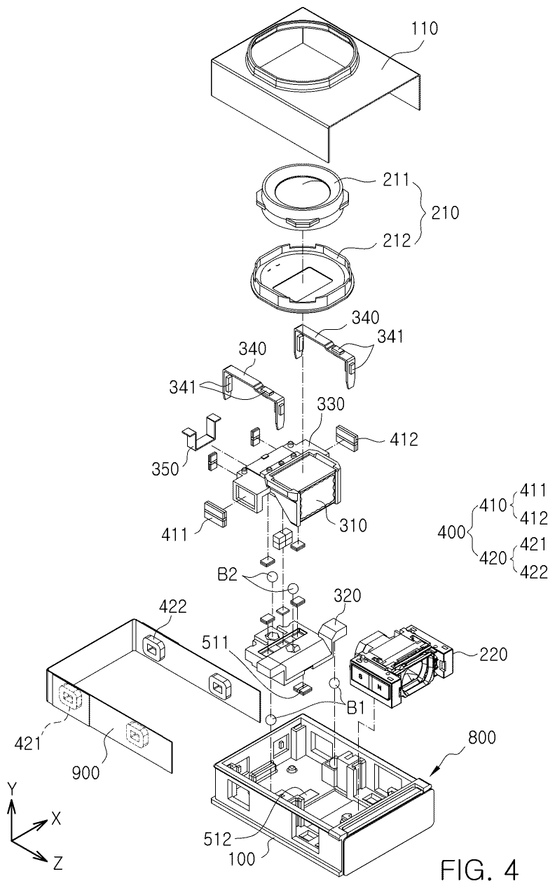

FIG. 1 illustrates a perspective view of an example camera module, in accordance with one or more embodiments, FIG. 2 and FIG. 3 are partially cutaway perspective views of an example camera module, in accordance with one or more embodiments, and FIG. 4 illustrates an exploded perspective view of an example camera module, in accordance with one or more embodiments.

Referring to FIGS. 1 to 4, an example camera module 1, in accordance with one or more embodiments, includes a reflection module 300 and a housing 100.

The reflection module 300 may be disposed within the housing 100 and includes a reflection member 310 having a reflection surface.

In an example embodiment, the housing 100 is described as a separately provided member, that is not included within the reflection module 300. However, this is only an example, and the housing 100 may also be provided as a component that is included within the reflection module 300. In this example, the reflection member 310, a guide member 320, and a holder 330 may be disposed within the housing 100.

The reflection member 310 may be disposed so as to be rotatable about two different axes for shake compensation. For example, the reflection member 310 may be rotatable about two axes perpendicular to each other, within the housing 100.

In an example embodiment, a camera module 10 may further include a first lens module 210.

The first lens module 210 includes at least one lens, and at least one lens has a first optical axis (Y-axis). The first optical axis (Y-axis) may extend in a vertical direction based on FIG. 4. The first optical axis (Y-axis) may pass through a center of the at least one lens of the first lens module 210.

In an example embodiment, the first lens module 210 includes a first lens barrel 211 and a first lens holder 212. At least one lens may be disposed in the first lens barrel 211, and the first lens barrel 211 may be coupled to the first lens holder 212. The first lens holder 212 may be coupled to the reflection module 300. Alternatively, the first lens module 210 may only include the first lens barrel 211 without including the first lens holder 212, and the first lens barrel 211 may also be coupled to the reflection module 300.

The first lens module 210 may be disposed in front of the reflection module 300. Here, “front” may refer to a direction that is closest to an object, or a positive first optical axis (Y-axis) direction (+Y-axis direction) based on the reflection module 300. For example, the first lens module 210 may be disposed above the reflection module 300 in the first optical axis (Y-axis) direction.

The first lens module 210 may be coupled to the reflection module 300. For example, the first lens holder 212 of the first lens module 210 may be coupled to the holder 330 of the reflection module 300.

The first lens module 210 and the reflection module 300 are disposed in the housing 100.

In an example embodiment, the camera module 1 may further include a second lens module 220. The reflection module 300 is disposed between the first lens module 210 and the second lens module 220. The second lens module 220 may include a plurality of lenses and has a second optical axis (Z-axis). The plurality of lenses are disposed along the second optical axis (Z-axis). The second optical axis (Z-axis) may pass through a center of the plurality of lenses of the second lens module 220.

The first optical axis (Y-axis) of the first lens module 210 and the second optical axis (Z-axis) of the second lens module 220 may be formed to be perpendicular to each other.

The first lens module 210 includes one or more lenses, and the second lens module 220 includes a plurality of lenses.

The one or more lenses of the first lens module 210 may be circular when viewed in the first optical axis (Y-axis) direction. At least one lens of the plurality of lenses of the second lens module 220 may be non-circular when viewed in the second optical axis (Z-axis) direction. For example, the non-circular lens may have different lengths in two directions, perpendicular to the second optical axis (Z-axis) direction, and perpendicular to each other. In an example embodiment, in the non-circular lens, a length thereof in the first axis (X-axis) direction, perpendicular to both the first optical axis (Y-axis) and the second optical axis (Z-axis), is longer than a length thereof in the first optical axis (Y-axis) direction.

The first lens module 210 and the reflection module 300 may be configured to rotate together for shake correction. The second lens module 220 may be moved in the second optical axis (Z-axis) direction for focus adjustment.

The camera module 1 may further include an image sensor module 800.

The image sensor module 800 includes a sensor housing, an image sensor, and a printed circuit board, and may further include an infrared cutoff filter.

The infrared cutoff filter may be mounted on the sensor housing. The infrared cutoff filter may block light in the infrared region, among the light passing through the second lens module.

The printed circuit board is coupled to a sensor housing, and the image sensor is disposed on the printed circuit board.

A reinforcing plate for rigidity reinforcement may be mounted on a rear surface of the printed circuit board (e.g., a surface opposite to a surface on which the image sensor is mounted).

A connector for electrical connection to a portable electronic device may be disposed on the printed circuit board.

The light passing through the second lens module 220 is received by the image sensor module 800 (e.g., an image sensor).

The camera module 1 may further include a case 110. The case 110 is coupled to the housing 100 so as to cover an upper portion of the housing 100. The case 110 may include an opening, and the first lens module 210 may be disposed in the opening.

In an example, at least a portion of the first lens module 210 may be disposed to protrude outside the housing 100 and the case 110.

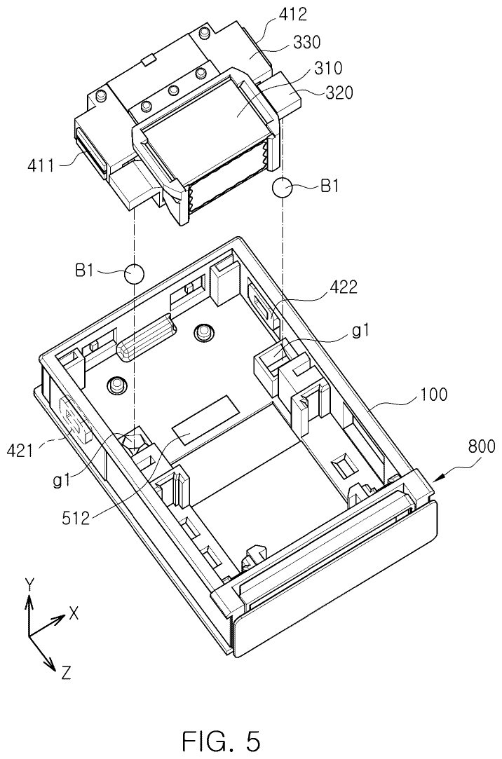

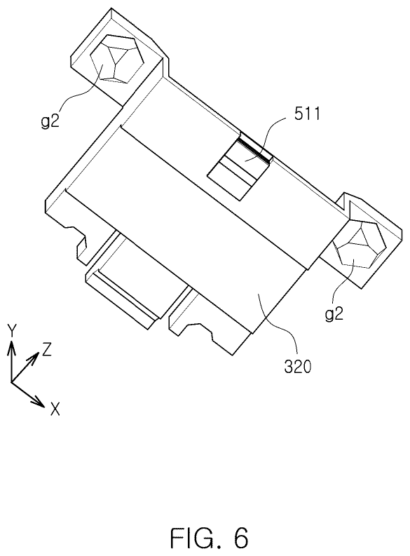

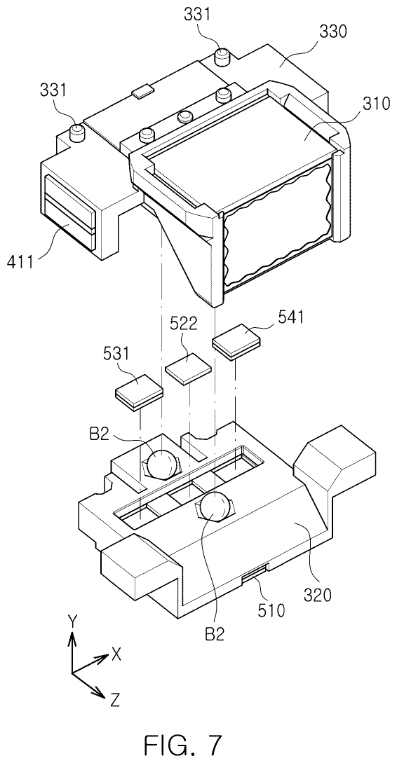

FIG. 5 illustrates an exploded perspective view of a reflection module and a housing, FIG. 6 illustrates a bottom perspective view of a guide member of the reflection module, and FIG. 7 illustrates a partially exploded perspective view of the reflection module.

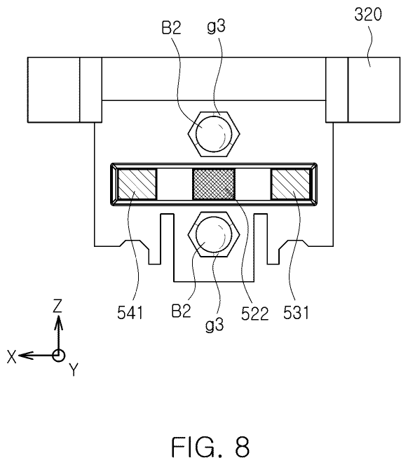

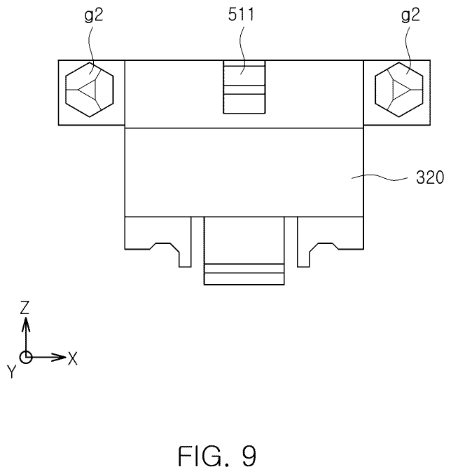

Additionally, FIG. 8 illustrates a plan view of a guide member, and FIG. 9 illustrates a bottom view of the guide member.

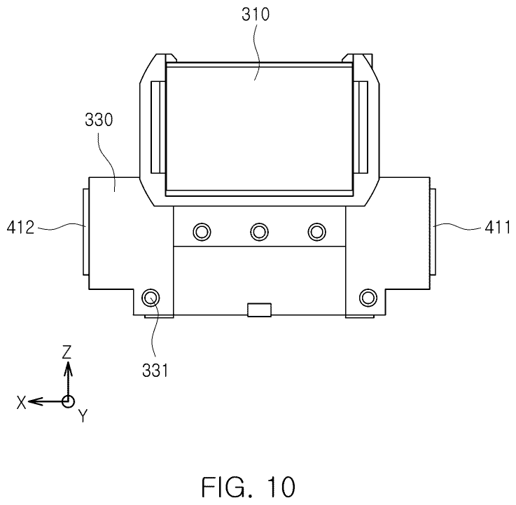

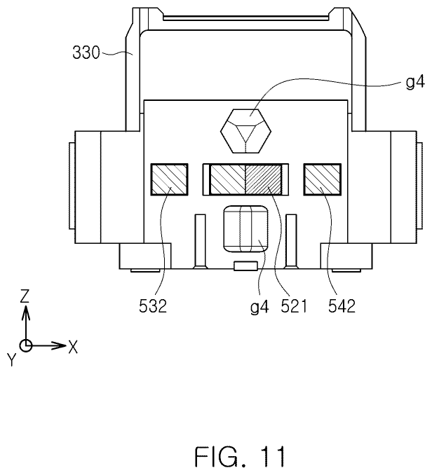

Additionally, FIG. 10 illustrates a plan view of a holder and a reflection member, and FIG. 11 is a bottom view of the holder.

Referring to FIGS. 5 to 11, a reflection module 300 (310, 320, 330) includes a reflection member 310, a holder 330, and a guide member 320.

The reflection member 310 has a reflection surface that reflects light passing through the first lens module 210. As examples, the reflection member 310 may be a prism or a mirror.

When the reflection member 310 is a prism, the reflection member 310 may have any shape obtained by dividing a rectangular solid (or cube) into two halves in a diagonal direction. The prism includes an incident surface on which light is incident, a reflection surface that reflects light passing through the incident surface, and an exit surface from which light reflected from the reflection surface is emitted.

The reflection member 310 is mounted on a holder 330. The first lens module 210 may be disposed in front of the reflection member 310, or on an object-side of the reflection member 310. In an example embodiment, the first lens module 210 may be mounted on the holder 330.

The holder 330 may be rotatably disposed on the guide member 320. Additionally, the guide member 320 may be rotatably disposed on the housing 100.

The guide member 320 may be rotatable about the first axis (X-axis), perpendicular to both the first optical axis (Y-axis) and the second optical axis (Z-axis), as a rotation axis. For example, the guide member 320 may be relatively rotatable on the housing 100 about the first axis (X-axis) as the rotation axis. In this example, the first lens module 210 and the holder 330 may also be rotated together with the guide member 320. The first axis (X-axis) may also be referred to as a first rotation axis.

The holder 330 may be rotated about a second optical axis (Z-axis), perpendicular to the first axis (X-axis), as a rotation axis. For example, the holder 330 may be relatively rotatable on the guide member 320 about the second optical axis (Z-axis), as a rotation axis. In this example, the first lens module 210 may be rotated together with the holder 330. In an example, the second optical axis (Z-axis) may also be referred to as a second rotation axis.

A first driver 400 may be provided to rotate the reflection module 300. The first driver 400 includes a driving magnet unit 410 and a coil unit 420. The guide member 320 may be relatively rotatable on the housing 100 based on the first axis (X-axis) by the first driver 400. Since the holder 330 and the first lens module 210 may be disposed on the guide member 320, the holder 330 and the first lens module 210 may also be rotated together with the guide member 320.

The driving magnet unit 410 may be mounted on the holder 330. In an example, the driving magnet unit 410 may be mounted on a side surface of the holder 330. The side surface of the holder 330 may refer to one surface of the holder 330 facing the housing 100 in the first axis (X-axis) direction.

The driving magnet unit 410 may include a plurality of magnets. In an example embodiment, the driving magnet unit 410 may include two magnets spaced apart from each other. The two magnets of the driving magnet unit 410 may be spaced apart from each other in the first axis (X-axis) direction.

For example, the driving magnet unit 410 includes a first driving magnet 411 and a second driving magnet 412 spaced apart from each other in the first axis (X-axis) direction.

The first driving magnet 411 may be disposed on one side surface of the holder 330, and the second driving magnet 412 may be disposed in the other side surface of the holder 330. One side surface of the holder 330 and the other side surface of the holder 330 may be spaced apart in the first axis (X-axis) direction.

The coil unit 420 may include a plurality of coils. In an example embodiment, the coil unit 420 may include two coils spaced apart from each other. The two coils of the coil unit 420 may be spaced apart from each other in the first axis (X-axis) direction.

In an example, the coil unit 420 includes a first coil 421 and a second coil 422 spaced apart from each other in the first axis (X-axis) direction. The first coil 421 may face the first driving magnet 411, and the second coil 422 may face the second driving magnet 412.

The first driving magnet 411 and the second driving magnet 412 may be magnetized so that one surface (e.g., a surface facing the coil unit 420) has both an N-pole and an S-pole.

In an example embodiment, one surface of the first driving magnet 411 facing the coil unit 420 and the other surface of the second driving magnet 412 may be polarized to have different polarities in the first optical axis (Y-axis) direction.

For example, a first surface of the first driving magnet 411 may sequentially have a first polarity, a neutral region and a second polarity along the first optical axis (Y-axis). A second surface (e.g., a surface opposite to the first surface) of the first driving magnet 411 may have a polarity opposite to a polarity of the first surface of the first driving magnet 411.

A first surface of the second driving magnet 412 may sequentially have a first polarity, a neutral region and a second polarity along the first optical axis (Y-axis). A second surface (e.g., a surface opposite to the first surface) of the second driving magnet 412 may have a polarity opposite to a polarity of the first surface of the second driving magnet 412.

The first polarity and the second polarity may be opposite to each other. For example, when the first polarity is an N-pole, the second polarity may be an S-pole.

The coil unit 420 may be disposed in a position facing the driving magnet unit 410. In an example embodiment, the first coil 421 may be disposed to face the first driving magnet 411 in the first axis (X-axis) direction. The second coil 422 may be disposed to face the second driving magnet 412 in the first axis (X-axis) direction.

The coil unit 420 is disposed on a substrate 900, and the substrate 900 is mounted on the housing 100 so that the driving magnet unit 410 and the coil unit 420 face each other in the first axis (X-axis) direction.

The housing 100 is provided with a through-hole that penetrates through the housing 100 in the first axis (X-axis) direction, and the coil unit 420 is disposed in the through-hole so as to directly face the driving magnet unit 410.

When the shake correction is performed, the driving magnet unit 410 is a movable member that is mounted on the holder 330 and rotates, and the coil unit 420 is a fixed member that is fixed to the substrate 900.

When power is applied to the first driver 400, the first driver 400 may generate a driving force necessary for rotation of the holder 330 and the guide member 320 with the first axis (X-axis) as the rotation axis. For example, the first driver 400 may generate a driving force in the first optical axis (Y-axis) direction.

In an example embodiment, a pair of magnets and coils may be disposed on one side of the reflection module 300 (e.g., a first driving magnet 411 and a first coil 421 disposed in a negative first axis direction (−X-axis direction) based on FIG. 4), and other pair of magnets and coils may be disposed on another side of the reflection module 300 (e.g., a second driving magnet 412 and a second coil 422 disposed in a positive first axis direction (+X-axis direction) based on FIG. 4 ).

When the guide member 320 and the holder 330 are rotated around the first axis (X-axis), a direction of the driving force of one pair of magnets and coils may be the same as a direction of the driving force of another pair of magnets and coils.

For example, when the direction of the driving force of the first driving magnet 411 and the first coil 421 is in a positive first optical axis (Y-axis) direction (+Y-axis direction), and the direction of the driving force of the second driving magnet 412 and the second coil 422 is also in the positive first optical axis (Y-axis) direction (+Y-axis direction), the guide member 320 and the holder 330 may be rotated together around the first axis (X-axis).

Additionally, when the direction of the driving force of the first driving magnet 411 and the first coil 421 is in the negative first optical axis (Y-axis) direction (−Y-axis direction), and the direction of the driving force of the second driving magnet 412 and the second coil 422 is also in the negative first optical axis (Y-axis) direction (−Y-axis direction), the guide member 320 and the holder 330 may be rotated together around the first axis (X-axis).

A first ball member B1 may be disposed between the guide member 320 and the housing 100. The first ball member B1 may be disposed between the guide member 320 and the housing 100 to form a rotation axis of the guide member 320.

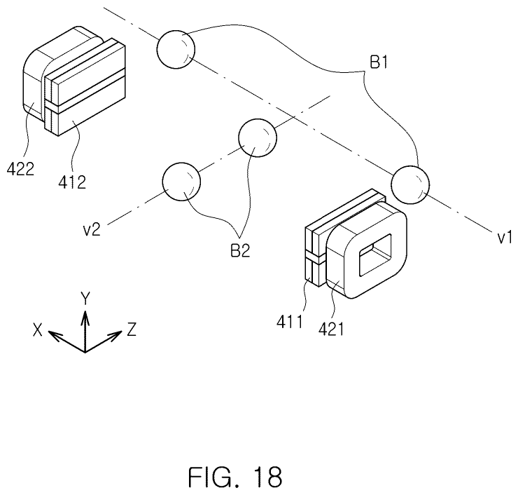

The first ball member B1 may include a plurality of balls that are spaced apart from each other in the first axis (X-axis). A virtual line v1 connecting a plurality of balls of the first ball member B1 in the first axis (X-axis) direction may be spaced apart from the first driver 400 in the second optical axis (Z-axis) direction (see FIG. 18).

In an example embodiment, the driving magnet unit 410 and the coil unit 420 may be spaced apart from the first ball member B1 in the second optical axis (Z-axis) direction. When a driving force is generated in the first optical axis (Y-axis) direction by the driving magnet unit 410 and the coil unit 420, the holder 330 may be rotated around the rotation axis formed by the first ball member B1. Since the holder 330 is disposed in the guide member 320, the holder 330 and the guide member 320 may be rotated together around the first axis (X-axis) by the first driver 400.

The virtual line v1 connecting the plurality of balls of the first ball member B1 in the first axis (X-axis) direction may pass through a reflection surface of the first reflection member 310.

In an example embodiment, when viewed from the first axis (X-axis) direction, a line extending the first optical axis (Y-axis) of the first lens module 210 may be disposed between opposite ends of the plurality of balls of the first ball member B1. In an example, the opposite ends of the plurality of balls of the first ball member B1 may refer to opposite ends in the second optical axis (Z-axis) direction.

An attractive force may be applied between the guide member 320 and the housing 100. A first pulling member 510 may be disposed between the guide member 320 and the housing 100.

The first pulling member 510 may include a first pulling magnet 511 and a first pulling yoke 512 facing each other. For example, the first pulling magnet 511 may be disposed on one of the guide member 320 and the housing 100, and the first pulling yoke 512 may be disposed on the other of the guide member 320 and the housing 100.

In an example embodiment, the first pulling magnet 511 may be disposed on a lower surface of the guide member 320, and the first pulling yoke 512 may be disposed on a bottom surface of the housing 100. Alternatively, the first pulling magnet 511 may be disposed on the bottom surface of the housing 100, and the first pulling yoke 512 may be disposed on the lower surface of the guide member 320.

The first pulling magnet 511 and the first pulling yoke 512 may face each other in the first optical axis (Y-axis) direction.

The first pulling magnet 511 and the first pulling yoke 512 may generate an attractive force between each other. In an example, the first pulling yoke 512 may be formed of a magnetic material. In an example, the first pulling yoke 512 may also be provided as a magnet.

An attractive force acts between the first pulling magnet 511 and the first pulling yoke 512 in the first optical axis (Y-axis) direction.

The attractive force between the first pulling magnet 511 and the first pulling yoke 512 allows the first ball member B1 to maintain contact with the guide member 320 and the housing 100, respectively.

One surface of the first pulling magnet 511 facing the first pulling yoke 512 may be configured to have a plurality of polarities. Accordingly, a magnetic flux of the first pulling magnet 511 may be concentrated on the first pulling yoke 512, thereby minimizing magnetic flux leakage.

The first pulling member 510 may be disposed between the plurality of balls of the first ball member B1.

A first guide groove g1 and a second guide groove g2 may be disposed on respective surfaces on which the guide member 320 and the housing 100 face each other (e.g., surfaces opposing each other in the first optical axis (Y-axis) direction). For example, the first guide groove g1 may be disposed on the housing 100, and the second guide groove g2 may be disposed on the guide member 320. The first guide groove g1 and the second guide groove g2 may face each other in the first optical axis (Y-axis) direction.

The first guide groove g1 includes a plurality of grooves spaced apart from each other in the first axis (X-axis) direction, and the second guide groove g2 includes a plurality of grooves spaced apart from each other in the first axis (X-axis) direction.

The first ball member B1 may be disposed between the first guide groove g1 and the second guide groove g2 to form a rotation axis of the guide member 320.

One groove, among the plurality of grooves of the first guide groove g1, may be in three-point contact with the first ball member B1, and another groove may be in two-point contact with the first ball member B1. For example, referring to FIG. 5, a groove disposed on the left, among the plurality of grooves of the first guide groove g1, may be in three-point contact with the first ball member B1, and a groove disposed on the right of the plurality of grooves of the first guide groove g1, may be in two-point contact with the first ball member B1.

Additionally, each of the plurality of grooves of the second guide groove g2 may be in three-point contact with the first ball member B1. However, this is only an example, and the shapes of the first guide groove g1 and the second guide groove g2 may also be reversed.

The first driver 400 may rotate the holder 330 around the second optical axis (Z-axis). That is, the holder 330 may be rotated around the second optical axis (Z-axis) by the first driver 400. Since the first lens module 210 is disposed on the holder 330, the first lens module 210 may also be rotated along with the holder 330.

When power is applied to the first driver 400, the first driver 400 may generate a driving force needed for rotation of the holder 330 with the second optical axis (Z-axis) as the rotation axis. In an example, the first driver 400 may generate a driving force in the first optical axis (Y-axis) direction.

In an example embodiment, when the holder 330 is rotated around the second optical axis (Z-axis), a direction of a driving force of one pair of magnets and coils may be opposite to a direction of a driving force of another pair of magnets and coils.

For example, when a direction of a driving force of the first driving magnet 411 and the first coil 421 is in the positive first optical axis (Y-axis) direction (+Y-axis direction), and a direction of a driving force of the second driving magnet 412 and the second coil 422 is in the negative first optical axis (Y-axis) direction (−Y-axis direction), the holder 330 may be rotated around the second optical axis (Z-axis).

Additionally, when the direction of the driving force of the first driving magnet 411 and the first coil 421 is in the negative first optical axis (Y-axis) direction (−Y-axis direction), and the direction of the driving force of the second driving magnet 412 and the second coil 422 is in the positive first optical axis (Y-axis) direction (+Y-axis direction), the holder 330 may be rotated around the second optical axis (Z-axis).

Additionally, the holder 330 may be rotated in the diagonal direction. For example, the guide member 320 and the holder 330 may be rotated around the first axis (X-axis) and the holder 330 may be rotated around the second optical axis (Z-axis) to rotate the holder 330 in the diagonal direction.

In an example embodiment, the holder 330 may be rotated in the diagonal direction by allowing a driving force to be generated only in one pair of magnets and coils and preventing the driving force from being generated in the other pair of magnets and coils. Alternatively, the holder 330 may be rotated in the diagonal direction by differently generating magnitudes (and/or directions) of a driving force from one pair of magnets and coils and magnitudes (and/or directions) of another pair of magnets and coils.

A second ball member B2 may be disposed between the holder 330 and the guide member 320. The second ball member B2 may be disposed between the holder 330 and the guide member 320 to form a rotation axis of the holder 330.

The second ball member B2 may include a plurality of balls spaced apart from each other in the second optical axis (Z-axis). A virtual line v2 connecting the plurality of balls of the second ball member B2 along the second optical axis (Z-axis) may be spaced apart from the first drive unit 400 in the first axis (X-axis) direction (see FIG. 18).

In an example embodiment, the drive magnet unit 410 and the coil unit 420 may be spaced apart from the second ball member B2 in the first axis (X-axis) direction. When a driving force is generated in the first optical axis (Y-axis) direction by the drive magnet unit 410 and the coil unit 420, the holder 330 may be rotated around a rotation axis formed by the second ball member B2.

The virtual line v2 connecting the plurality of balls of the second ball member B2 in the second optical axis (Z-axis) direction may pass through the reflection surface of the first reflection member 310.

In an example embodiment, when viewed from the first axis (X-axis), a line extending along the second optical axis (Z-axis) of the second lens module 220 may be disposed between opposite ends of the plurality of balls of the second ball member B2. Here, the opposite ends of the plurality of balls of the second ball member B2 may refer to opposite ends in the first optical axis (Y-axis) direction.

A third guide groove g3 and a fourth guide groove g4 may be disposed on respective surfaces on which the holder 330 and the guide member 320 face each other (e.g., surfaces opposing each other in the first optical axis (Y-axis) direction). In an example, the third guide groove g3 may be disposed in the guide member 320, and the fourth guide groove g4 may be disposed in the holder 330. The third guide groove g3 and the fourth guide groove g4 may face each other in the first optical axis (Y-axis) direction.

The third guide groove g3 includes a plurality of grooves spaced apart from each other in the second optical axis (Z-axis) direction, and the fourth guide groove g4 includes a plurality of grooves spaced apart from each other in the second optical axis (Z-axis) direction.

The second ball member B2 may be disposed between the third guide groove g3 and the fourth guide groove g4 to form a rotation axis of the holder 330.

One of the plurality of grooves of the fourth guide groove g4 may be in three-point contact with the second ball member B2, and another of the plurality of grooves of the fourth guide groove g4 may be in two-point contact with the second ball member B2. For example, referring to FIG. 11, a groove disposed in an upper portion, among the plurality of grooves of the fourth guide groove g4, may be in three-point contact with the second ball member B2, and a groove disposed in a lower portion, among the plurality of grooves of the fourth guide groove g4, may be in two-point contact with the second ball member B2.

Additionally, each of the plurality of grooves of the third guide groove g3 may be in three-point contact with the second ball member B2. A shape of the third guide groove g3 and a shape of the fourth guide groove g4 may be reversed from each other.

An attractive force may be applied between the holder 330 and the guide member 320. A second pulling member 520 may be disposed between the holder 330 and the guide member 320.

The second pulling member 520 may include a second pulling magnet 521 and a second pulling yoke 522 facing each other. For example, the second pulling magnet 521 may be disposed in one of the holder 330 and the guide member 320, and the second pulling yoke 522 may be disposed in the other of the holder 330 and the guide member 320.

In an example embodiment, the second pulling magnet 521 may be disposed on the holder 330, and the second pulling yoke 522 may be disposed on the guide member 320. As another example, the second pulling magnet 521 may be disposed on the guide member 320, and the second pulling yoke 522 may be disposed on the holder 330.

The second pulling magnet 521 and the second pulling yoke 522 may face each other in the first optical axis (Y-axis) direction.

In an example embodiment, the second pulling magnet 521 may be disposed on a lower surface of the holder 330, and the second pulling yoke 522 may be disposed on an upper surface of the guide member 320.

The second pulling magnet 521 may be disposed between a plurality of grooves of the fourth guide groove g4. Additionally, the second pulling yoke 522 may be disposed between a plurality of grooves of the third guide groove g3.

The second pulling magnet 521 and the second pulling yoke 522 may generate an attractive force between each other. For example, the second pulling yoke 522 may be formed of a magnetic material. The second pulling yoke 522 may also be provided as a magnet.

An attractive force acts between the second pulling magnet 521 and the second pulling yoke 522 in the first optical axis (Y-axis) direction. That is, the second pulling unit 520 may generate a force that pulls the guide member 320 and the holder 330 together.

The attractive force between the second pulling magnet 521 and the second pulling yoke 522 allows the second ball member B2 to maintain contact with the guide member 320 and the holder 330, respectively.

One surface of the second pulling magnet 521, facing the second pulling yoke 522, may be configured to have a plurality of polarities. Accordingly, a magnetic flux of the second pulling magnet 521 may be concentrated on the second pulling yoke 522, thereby minimizing magnetic flux leakage.

The second pulling unit 520 may be disposed between the plurality of balls of the second ball member B2.

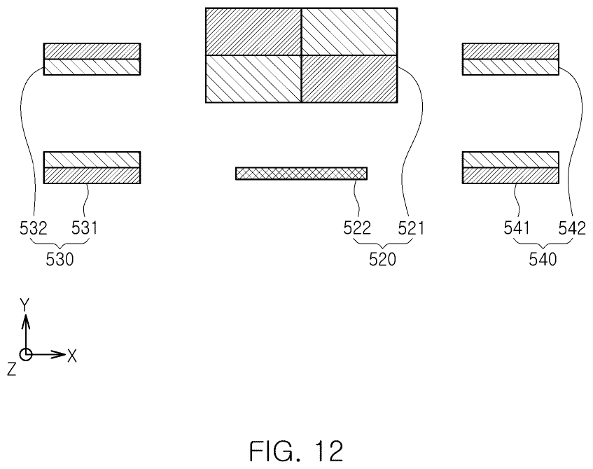

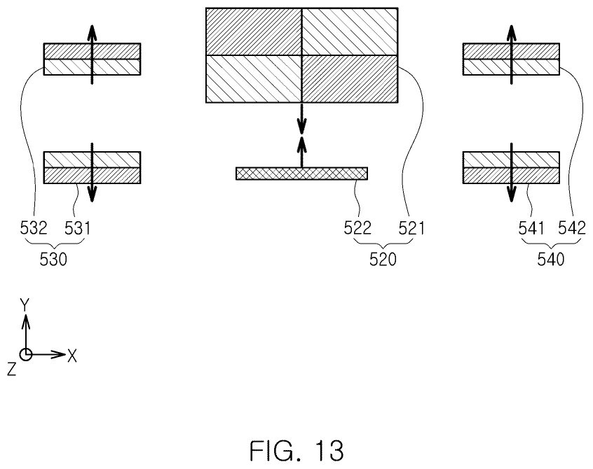

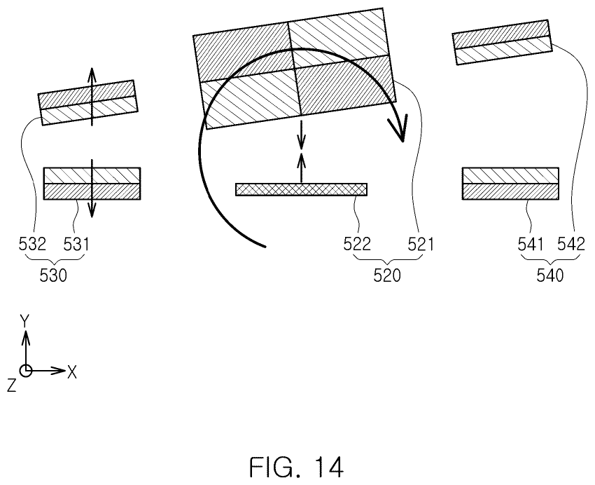

FIG. 12 is a schematic cross-sectional view of the first magnetic member, the second magnetic member and the second pulling unit, and FIGS. 13 and 14 are views illustrating an attractive force and a repulsive force acting between a guide member and a holder.

The reflection module 300 according to an example embodiment of the present disclosure may further include a plurality of magnetic members. In an example embodiment, the plurality of magnetic members include a first magnetic member 530 and a second magnetic member 540.

The first magnetic member 530 and the second magnetic member 540 may be spaced apart from each other in the first axis (X-axis) direction. The second pulling unit 520 may be disposed between the first magnetic member 530 and the second magnetic member 540. For example, the first magnetic member 530 and the second magnetic member 540 may be spaced apart from each other in the first axis (X-axis) direction with respect to the second optical axis (Z-axis).

In an example embodiment, a second pulling unit 520 may be disposed between the first magnetic member 530 and the second magnetic member 540 when viewed from the first optical axis (Y-axis) direction.

In an example embodiment, a third plane passing through the second pulling unit 520 may be disposed between a first plane passing through the first magnetic member 530 and a second plane passing through the second magnetic member 540. Here, the first plane, the second plane and the third plane may all be Y-Z planes.

The first magnetic member 530 includes a first magnet 531. In an example embodiment, the first magnet 531 may be disposed on the guide member 320.

The second magnetic member 540 includes a second magnet 541. In an example embodiment, the second magnet 541 may be disposed on the guide member 320.

The first magnet 531 and the second magnet 541 may be spaced apart from each other in the first axis (X-axis) direction.

The first magnetic member 530 may further include a third magnet 532. The first magnet 531 and the third magnet 532 may face each other in the first optical axis (Y-axis) direction.

The third magnet 532 may be disposed in the holder 330.

The first magnetic member 530 may generate a force that pushes the guide member 320 and the holder 330. For example, repulsive force acts between the first magnet 531 and the third magnet 532.

One surface of the first magnet 531 and one surface of the third magnet 532 facing each other may have the same polarity. For example, one surface of the first magnet 531 and one surface of the third magnet 532, which oppose each other, may both have an N-pole. Conversely, one surface of the first magnet 531 and one surface of the third magnet 532, which oppose each other, may be configured to both have an S-pole.

The second magnetic member 540 may further include a fourth magnet 542. The second magnet 541 and the fourth magnet 542 may face each other in the first optical axis (Y-axis) direction.

The fourth magnet 542 may be disposed in the holder 330.

The second magnetic member 540 may generate a force that pushes the guide member 320 and the holder 330 toward each other. For example, a repulsive force may act between the second magnet 541 and the fourth magnet 542.

One surface of the second magnet 541 and one surface of the fourth magnet 542, opposing each other, may have the same polarity. For example, both the first surface of the second magnet 541 and the first surface of the fourth magnet 542 may have an N-pole. Conversely, both the first surface of the second magnet 541 and the first surface of the fourth magnet 542 may have an S-pole.

In an example embodiment, an acting direction of a magnetic force of the second pulling member 520 and an acting direction of a magnetic force of the first magnetic member 530 may be opposite to each other. Additionally, the acting direction of the magnetic force of the second pulling member 520 and the acting direction of the magnetic force of the second magnetic member 540 may be opposite to each other.

Both an attractive force and a repulsive force may occur between the guide member 320 and the holder 330. In an example, a region on which an attractive force acts may be a central region of a portion in which the guide member 320 and the holder 330 face each other, and a region on which a repulsive force acts may be an outer region of a portion in which the guide member 320 and the holder 330 face each other.

Additionally, the region on which the attractive force acts may be disposed closer to the second ball member B2 than the region on which the repulsive force acts.

A magnitude of the attractive force of the second pulling member 520 may be greater than the sum of the repulsive force of the first magnetic member 530 and the repulsive force of the second magnetic member 540.

Accordingly, the second ball member B2 may maintain contact with the guide member 320 and the holder 330, respectively.

In an example embodiment, an area in which the second pulling magnet 521 and the second pulling yoke 522 of the second pulling unit 520 face each other may be greater than the sum of an area in which magnets of the first magnetic member 530 face each other and an area in which magnets of the second magnetic member 540 face each other.

In an example embodiment, a gap between the second pulling magnet 521 and the second pulling yoke 522 of the second pulling unit 520 may be narrower than a gap between the first magnet 531 and the third magnet 532 of the first magnetic member 530.

A gap between the second pulling magnet 521 of the second pulling unit 520 and the second pulling yoke 522 may be narrower than a gap between the second magnet 541 and the fourth magnet 542 of the second magnetic member 540.

When rotation of the holder 330 causes one side of the first magnet 531 and one side of the third magnet 532 to become relatively closer, repulsive force between one side of the first magnet 531 and one side of the third magnet 532 increases, thereby allowing the holder 330 to return to an original position thereof in a state which no power is applied to the reflection module 300.

In an example, the original position refers to a state in which the holder 330 is not rotated, for example, a state in which the first magnet 531 and the third magnet 532 are parallel to each other (or a state in which the second magnet 541 and the fourth magnet 542 are parallel, or a state in which the second pulling magnet 521 and the second pulling yoke 522 are parallel).

That is, the reflection module 300, in accordance with one or more embodiments, may mechanically implement a centering structure for the holder 330 to reduce power consumption to position the holder 330.

Accordingly, when shake correction is not required (e.g., when no power is supplied to the reflection module 300, etc.), a position of the holder 330 may be adjusted without additional power consumption.

In an example, the attractive force and the repulsive force acting structure between the holder 330 and the guide member 320 may also be applied between the guide member 320 and the housing 100.

In this example, the first magnetic member 530 and the second magnetic member 540 may be disposed between the guide member 320 and the housing 100, and the first magnetic member 530 and the second magnetic member 540 may be spaced apart from each other in the second optical axis (Z-axis) direction.

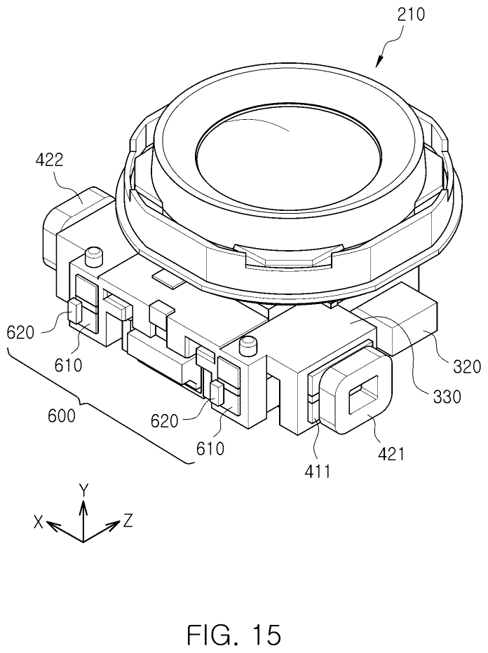

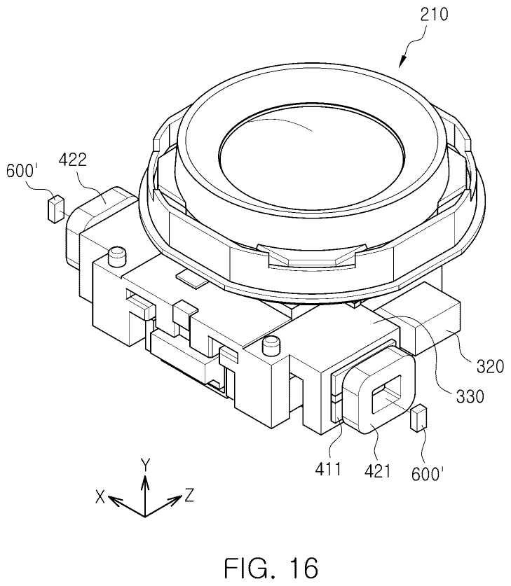

FIG. 15 is a perspective view of a reflection module and a first lens module, and FIG. 16 is a view illustrating a modified example of FIG. 15.

First, referring to FIG. 15, the camera module 1 may detect a position of the holder 330. For this purpose, a position sensing unit 600 is provided.

When rotating around the first axis (X-axis), the guide member 320 and the holder 330 rotate together, and when rotating around the second optical axis (Z-axis), the holder 330 relatively rotates on the guide member 320. Additionally, since the holder 330 may be equipped with a reflection member 310, a position of the reflection member 310 may be sensed by sensing the position of the holder 330.

The position sensing unit 600 includes a sensing magnet 610 and a first position sensor 620.

The sensing magnet 610 may be disposed on the holder 330. For example, the sensing magnet 610 may be disposed on a rear surface of the holder 330. One surface of the sensing magnet 610 (e.g., a surface facing the first position sensor 620) may be magnetized to have an N-pole, a neutral region, and an S-pole in the first optical axis (Y-axis) direction.

The first position sensor 620 may be disposed in a position facing the sensing magnet 610 (e.g., a position facing the second optical axis (Z-axis) direction). The first position sensor 620 may be disposed on the substrate 900.

In the original position, the neutral region of the sensing magnet 610 may face the first position sensor 620. In an example, the original position may refer to a state in which the holder 330 and the guide member 320 are not rotated, for example, a state in which the second pulling magnet 521 and the second pulling yoke 522 are parallel to a bottom surface of the housing 100.

When the guide member 320 and the holder 330 are rotated around the first axis (X-axis) as the rotation axis, a distance between the sensing magnet 610 and the first position sensor 620 in the second optical axis (Z-axis) direction changes, thereby detecting the position of the guide member 320.

When the holder 330 is rotated around the second optical axis (Z-axis) as the rotation axis, a polarity area of the one surface of the sensing magnet 610 facing the first position sensor 620 changes, thereby detecting the position of the holder 330.

The first position sensor 620 may be a Hall sensor or a tunneling magnetoresistance (TMR) sensor.

In an example, the sensing magnet 610 may include a plurality of magnets spaced apart from each other in the first axis (X-axis) direction, and the first position sensor 620 may include a plurality of Hall sensors spaced apart from each other in the first axis (X-axis) direction.

When the sensing magnet 610 and the first position sensor 620 are provided in plural, the accuracy of position sensing may be improved.

In an example embodiment, the plurality of sensing magnets 610 may be spaced apart from each other. For example, the plurality of sensing magnets 610 may be spaced apart from each other in the first axis (X-axis) direction.

Additionally, the virtual line v2 connecting the plurality of balls of the second ball member B2 may be disposed between the plurality of sensing magnets 610. A distance from the virtual line v2 connecting the plurality of balls of the second ball member B2 to each sensing magnet 610 may be the same.

One surface of each sensing magnet 610 (e.g., a surface facing the first position sensor 620) may have an S-pole, a neutral region and an N-pole, sequentially, in the positive first optical axis (Y-axis) direction (+Y-axis direction). That is, polarity magnetization shapes of the plurality of sensing magnets 610 may be identical.

Hereinafter, a sensing method of the position sensing unit 600 when the polarity magnetization shape of the plurality of sensing magnets 610 are identical will be described.

When the guide member 320 and the holder 330 are rotated about the first axis (X-axis) as the rotation axis, all of the plurality of first position sensors 620 may move away from a same polarity, or may move closer to a same polarity.

For example, by rotating the guide member 320 and the holder 330, all of the first position sensors 620 may move away from the N-pole, and may move closer to the S-pole, or all of the first position sensors 620 may move away from the S-pole, and may move closer to the N-pole. Accordingly, signal values output from the plurality of first position sensors 620 have the same shape.

When the guide member 320 and the holder 330 are rotated around the first axis (X-axis) as the rotation axis, signal values output from the plurality of first position sensors 620 may be summed to accurately detect the position of the holder 330.

When the holder 330 is rotated around the second optical axis (Z-axis), when one of the plurality of first position sensors 620 moves closer to the N-pole and away from the S-pole, the other thereof may move closer to the S-pole and away from the N-pole. Accordingly, a signal value output from one of the plurality of first position sensors 620 and a signal value output from another thereof may have different shapes.

For example, when the signal value output from one of the plurality of first position sensors 620 is in the form of an up-right straight line, the signal value output from another of the plurality of first position sensors 620 may be in the form of a down-right straight line. In other words, a graph of the signal values output from the plurality of first position sensors 620 may be in the form of an X.

When the holder 330 rotates around the second optical axis (Z-axis) as the rotation axis, a difference between the signal values output from the plurality of first position sensors 620 may be calculated to accurately detect the position of the holder 330.

In an example embodiment, one surface of one of the plurality of sensing magnets 610 may have an S-pole, a neutral region and an N-pole, sequentially in the positive first optical axis (Y-axis) direction (+Y-axis direction). Additionally, one surface of the other of the plurality of sensing magnets 610 may sequentially have an N-pole, a neutral region and an S-pole in the positive first optical axis (Y-axis) direction (+Y-axis direction).

Hereinafter, a sensing method of the position sensing unit 600 when the polarity magnetization patterns of the plurality of sensing magnets 610 are different will be described.

In the example in which the guide member 320 and the holder 330 rotate around the first axis (X-axis), when one of the plurality of first position sensors 620 approaches the N-pole and moves away from the S-pole, the other thereof may approach the S-pole and move away from the N-pole. Accordingly, the signal value output from one of the plurality of first position sensors 620 and the signal value output from the other thereof may have different shapes.

For example, when the signal value output from one of the plurality of first position sensors 620 is in the form of an up-right straight line, a signal value output from another of the plurality of first position sensors 620 may be in the form of a down-right straight line. In other words, a graph of the signal values output from the plurality of first position sensors 620 may be in the form of an X.

When the guide member 320 and the holder 330 are rotated around the first axis (X-axis) as the rotation axis, a difference between the signal values output from the plurality of first position sensors 620 may be calculated to accurately detect the position of the guide member 320.

When the holder 330 is rotated around the second optical axis (Z-axis) as the rotation axis, all of the plurality of first position sensors 620 move away from a same polarity, or move closer to a same polarity. For example, by rotating the holder 330, all of the first position sensors 620 may move away from the N-pole and move closer to the S-pole, or all of the plurality of first position sensors 620 may move away from the S-pole and move closer to the N-pole. Accordingly, the signal values output from the plurality of first position sensors 620 have the same shape.

When the holder 330 rotates around the second optical axis (Z-axis) as the rotation axis, the signal values output from the plurality of first position sensors 620 may be summed to accurately detect the position of the holder 330.

In summary, the signal values output from the plurality of first position sensors 620 may be summed to generate a first position signal of the holder 330, and a difference between the signal values output from the plurality of first position sensors 620 may be calculated to generate a second position signal of the holder 330.

In an example, the first position signal may be a position signal indicative of either a rotation of the holder 330 around the first rotation axis or a rotation of the holder 330 around the second rotation axis, and the second position signal may be a position signal indicative of either a rotation of the holder 330 around the first rotation axis or a rotation of the holder 330 around the second rotation axis.

The position sensing unit 600 may further include a controller. The controller may be a driver IC. In an example embodiment, the driver IC and the first position sensor 620 may be provided as a single chip.

By feedback-controlling the signal values output from the plurality of first position sensors 620, the position sensing unit 600 may apply power in an appropriate direction and magnitude to the coil unit 420 so that the holder 330 and the guide member 320 may be disposed in a target position.

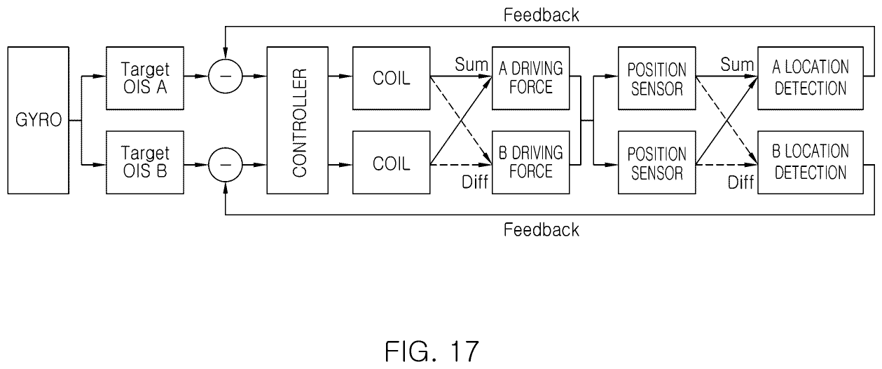

Referring to FIG. 17, the reflection module 300 may further include a gyro. The gyro may be a sensor that senses an attitude value of the holder 330. Alternatively, when the reflection module 300 does not include the gyro, a gyro mounted on a portable electronic device may be used. That is, since the reflection module 300 is mounted on a portable electronic device, an output value of the gyro mounted on the portable electronic device may be used.

When a shake correction value is calculated based on the attitude value output from the gyro (Target OIS A or Target OIS B), and the shake correction value is input to the controller, the controller may apply current to at least one of the first coil 421 and the second coil 422. This may allow the holder 330 to rotate.

In FIG. 17, A may refer to either a rotation around the first axis (X-axis) or a rotation around the second optical axis (Z-axis). Accordingly, when A refers to the rotation around the first axis (X-axis), B may refer to the rotation around the second optical axis (Z-axis).

For example, in FIG. 17, Target OIS A may be a target position of the holder 330 rotated around the first axis (X-axis). Target OIS B may be a target position of the holder 330 rotated around the second optical axis (Z-axis). The A driving force may be a driving force to rotate the holder 330 around the first axis (X-axis), and the B driving force may be a driving force to rotate the holder 330 around the second optical axis (Z-axis). Position detection A may refer to sensing the position of the holder 330 based on the first axis (X-axis), and position detection B may refer to sensing the position of the holder 330 based on the second optical axis (Z-axis).

When magnetization forms of the polarities of the first driving magnet 411 and the second driving magnet 412 are the same, current may be applied in the same direction to the first coil 421 and the second coil 422, so that the driving force may be generated to rotate the guide member 320 and the holder 330 around the first axis (X-axis) (The ‘Sum’ symbol of the coil in FIG. 17 may indicate applying current in the same direction to the first coil 420 and the second coil 422).

Additionally, currents may be applied in opposite directions to the first coil 421 and the second coil 422, so that the driving force may be generated to rotate the holder 330 around the second optical axis (Z-axis) (The symbol “Diff” in FIG. 17 may indicate applying currents in opposite directions to the first coil 421 and the second coil 422).

However, the one or more examples are not limited thereto, and the magnetization forms of the polarities of the plurality of driving magnet units 410 and the current application directions of the coil units 420 to generate a driving force in one direction may be configured in various manners.

The signal values output from the plurality of first position sensors 620 may be summed to accurately detect the position of the holder 330. Additionally, the difference between the signal values output from the plurality of first position sensors 620 may be calculated to accurately detect the position of the holder 330.

Additionally, by feedback-controlling the signal values output from the plurality of first position sensors 620, power may be applied to the coil unit 420 in an appropriate direction and magnitude so that the holder 330 and the guide member 320 may be disposed in a target position.

When the holder 330 is disposed in an original position, the virtual line v1 connecting the plurality of balls of the first ball member B1 may overlap the neutral region of the sensing magnet 610 when viewed from the second optical axis (Z-axis). Additionally, the virtual line v1 connecting the plurality of balls of the first ball member B1 may overlap the first position sensor 620 when viewed from the second optical axis (Z-axis).

The virtual line v2 connecting the plurality of balls of the second ball member B2 may overlap the neutral region of the sensing magnet 610 when viewed from the first axis (X-axis). Additionally, the virtual line v2 connecting the plurality of balls of the second ball member B2 may overlap the first position sensor 620 when viewed from the first axis (X-axis).

Referring to FIG. 15, the driving magnet 410 of the first driver 400 is disposed on both side surfaces of the holder 330 spaced apart from each other in the first axis (X-axis), and the sensing magnet 610 of the position sensing unit 600 is disposed on a rear surface of the holder 330, perpendicular to the both side surfaces of the holder 330.

Unlike FIG. 15, the position of the first driver 400 and the position sensing unit 600 may also be interchanged.

When the position of the first driver 400 and the position of the position sensing unit 600 are interchanged, the sensing magnets 610 of the position sensing unit 600 may be disposed on both side surfaces of the holder 330 spaced apart from each other in the first axis (X-axis) direction, and the driving magnet unit 410 of the first driver 400 may be disposed on a rear surface of the holder 330, perpendicular to the both sides of the holder 330. In this example, the first driving magnet 411 and the second driving magnet 412 of the driving magnet unit 410 may be spaced apart from each other on the rear surface of the holder 330 in the first axis (X-axis) direction.

In an example, referring to FIG. 16, a position sensing unit 600′ may be configured to include only a plurality of first position sensors, and may not include a plurality of sensing magnets. That is, in an example embodiment of FIG. 16, the position sensing unit 600′ does not include a plurality of sensing magnets 610.

In this example, the plurality of first position sensors may be disposed in a position in which a position of the driving magnet unit 410 may be detected (e.g., a position in which a magnetic field of the first driving magnet 411 and a magnetic field of the second driving magnet 412 may pass through the first position sensor).

In an example embodiment, the plurality of first position sensors may be disposed inside or outside the coil unit 420.

Referring to FIG. 16, one of the plurality of first position sensors is illustrated as being disposed inside the first coil 421 and the other is illustrated as being disposed inside the second coil 422. However, the one or more examples are not limited thereto, and the plurality of first position sensors may also be disposed outside the first coil 421 and outside the second coil 422.

A position sensing method of the holder 330 is the same as that of the embodiment of FIG. 15.

In an example, although not illustrated in the drawing, a spacer may be disposed on a lower surface of the first lens module 210 (i.e., a lower surface of the first lens holder 212 facing the reflection member 310). The spacer has an entrance hole through which light passes, and the entrance hole may be non-circular. For example, the entrance hole may have a shape like a running track. That is, an inner surface of the spacer forming the entrance hole may include two flat surfaces extending parallel to each other and two curved surfaces connecting the two flat surfaces.

The inner surface of the spacer may have a waveform with alternating concave and convex shapes, thereby preventing a flare phenomenon.

Referring to FIG. 4, the camera module 1 may include a first stopper 340. The first stopper 340 may be coupled to the housing 100 to cover at least a portion of the reflection module 300. For example, the first stopper 340 may cover at least a portion of an upper surface of the holder 330. The first stopper 340 and the holder 330 may be spaced apart from each other in the first optical axis (Y-axis) direction. Additionally, the first stopper 340 and the holder 330 may be spaced apart from each other in the second optical axis (Z-axis) direction.

Since the first stopper 340 is spaced apart from the reflection module 300, the reflection module 300 may be prevented from deviating from the housing 100 due to an external impact, or the like, without impeding the rotation of the reflection module 300.

A buffer member 341 having an elastic force may be coupled to the first stopper 340. The buffer member 341 may be disposed on at least one of a first surface and a second surface of the first stopper 340. The first surface of the first stopper 340 may be a surface facing the case 110 in the first optical axis (Y-axis) direction, and the second surface of the first stopper 340 may be a surface facing the holder 330 in the first optical axis (Y-axis) direction.

Additionally, the buffer member 341 may also be disposed on a side surface of the first stopper 340. The side surface of the first stopper 340 may be a surface facing the holder 330 in the second optical axis (Z-axis) direction.

In an example, a second stopper 350 may be coupled to the guide member 320 or the holder 330. In an example embodiment, the second stopper 350 may be fixed to the holder 330, and a portion of the second stopper 350 may extend toward the guide member 320. A coupling portion to which the second stopper 350 is coupled may be disposed in the holder 330. The coupling portion may have a groove or a hole shape.

A receiving portion that accommodates a portion of the second stopper 350 may be disposed in the guide member 320. The receiving portion may have a groove or a hole shape.

The second stopper 350 may be fixed to a coupling portion of the holder 330, and a portion of the second stopper 350 may extend toward the guide member 320 and may be accommodated in the receiving portion of the guide member 320.

A portion of the second stopper 350 may be spaced apart from the receiving portion. An end of a portion of the second stopper 350 may curvedly extend within the receiving portion. A portion of the second stopper 350 and the receiving portion of the guide member 320 may have corresponding shapes.

In an example embodiment, the end of the portion of the second stopper 350 and the receiving portion may face each other in the first optical axis (Y-axis) direction.

Accordingly, the second stopper 350 may prevent the holder 330 from deviating from the guide member 320 due to an external impact, or the like, without impeding the rotation of the holder 330.

A buffer member 101 may be disposed on at least one of surfaces on which the guide member 320 and the housing 100 face each other (e.g., a surface facing the first lens module 210 in the first optical axis (Y-axis) direction).

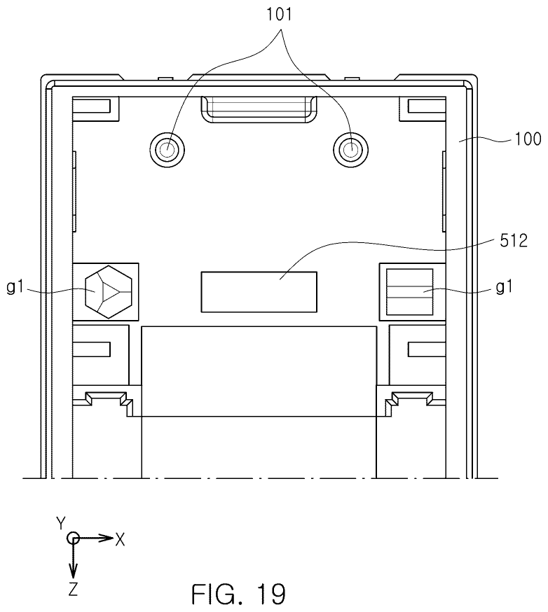

For example, referring to FIG. 19, an elastic buffer member 101 may be disposed on an internal bottom surface of the housing 100. The internal bottom surface of the housing 100 may be a surface that faces the guide member 320 in the first optical axis (Y-axis) direction. As another example, the buffer member 101 may be disposed on a lower surface of the guide member 320 (e.g., a surface that faces the internal bottom surface of the housing 100 in the first optical axis (Y-axis) direction).

Accordingly, when the guide member 320 rotates around the first axis (X-axis), a rotation range may be limited, and when the guide member 320 and the housing 100 collide with each other, the amount of impact and noise may be reduced.

A buffer member may be disposed on at least one of surfaces on which the holder 330 and the first stopper 340 face each other (for example, a surface facing the first lens module 210 in the first optical axis (Y-axis) direction).

For example, referring to FIG. 7, a buffer member 331 may be disposed on an upper surface of the holder 330 (a surface facing a lower surface of the first stopper 340 in the first optical axis (Y-axis) direction). The buffer member 331 may be formed of an elastic material.

Accordingly, when the holder 330 rotates around the second optical axis (Z-axis), the rotation range may be limited, and when the holder 330 and the first stopper 340 collide with each other, the impact and noise may be reduced.

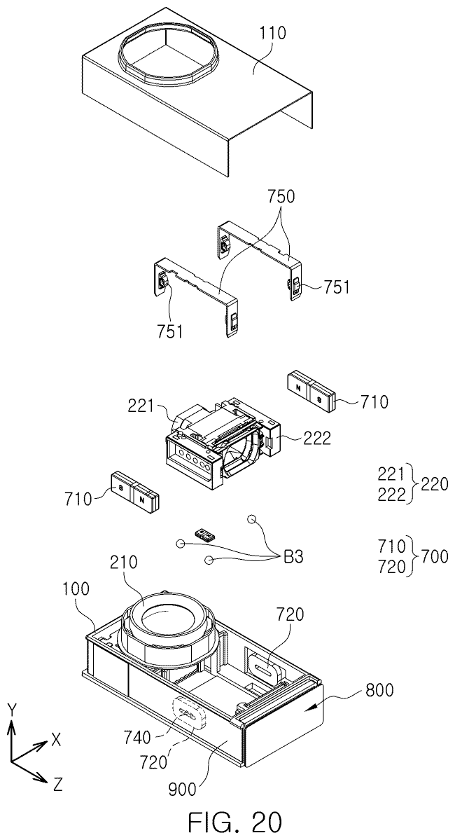

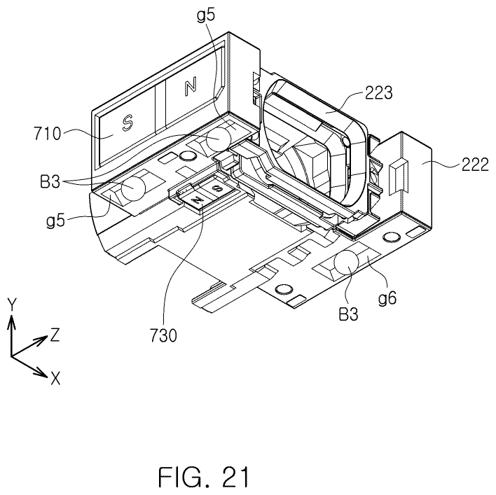

FIG. 20 is a perspective view illustrating a second lens module separated from a camera module, in accordance with one or more embodiments, and FIG. 21 is a bottom perspective view of the second lens module.

Referring to FIG. 20, a second lens module 220 may be disposed between the reflection module 300 and the image sensor module 800.

The second lens module 220 may be moved in the second optical axis (Z-axis) direction for the purpose of performing focus adjustment.

In an example embodiment, the second lens module 220 includes a second lens barrel 221 and a second lens holder 222. A plurality of lenses may be disposed within the second lens barrel 221, and the second lens barrel 221 may be coupled to the second lens holder 222.

The camera module 1 may include a second driver 700 to move the second lens module 220 in the second optical axis (Z-axis) direction.

The second driver 700 includes a third driving magnet 710 and a third coil 720. The third driving magnet 710 and the third coil 720 may be disposed to face each other in a direction, perpendicular to the second optical axis (Z-axis).

The third driving magnet 710 is mounted on the second lens module 220. For example, the third driving magnet 710 may be disposed on a side surface of the second lens module 220.

In an example embodiment, the third driving magnet 710 may include two magnets, and one magnet of the third driving magnet 710 may be mounted on a first side surface of the second lens module 220, and a second magnet of the third driving magnet 710 may be mounted on a second side surface of the second lens module 220. The first side surface of the second lens module 220 and the second side surface of the second lens module 220 may be spaced apart from each other in the first axis (X-axis) direction.

The third driving magnet 710 may be magnetized so that one surface thereof (e.g., a surface facing the third coil 720) has both an N-pole and an S-pole. For example, the one surface of the third driving magnet 710 facing the third coil 720 may be sequentially provided with an N-pole, a neutral region and an S-pole along the second optical axis (Z-axis) direction.

The third coil 720 is disposed to face the third driving magnet 710. For example, the third coil 720 may be disposed to face the third driving magnet 710 in a direction, perpendicular to the second optical axis (Z-axis) direction (e.g., in the first axis (X-axis) direction).

The third coil 720 is disposed on the substrate 900, and the substrate 900 is mounted on the housing 100 so that the third driving magnet 710 and the third coil 720 face each other in the first axis (X-axis) direction. In an example embodiment, the third coil 720 may include two coils spaced apart from each other in the first axis (X-axis) direction.

The housing 100 is provided with a through-hole that penetrates through the housing 100, and the third coil 720 disposed on the substrate 900 may directly face the third driving magnet 710 through the through-hole.

During focus adjustment, the third driving magnet 710 is a moving member hat is tmounted on the second lens module 220 and moving with the second lens module 220 in the second optical axis (Z-axis) direction, and the third coil 720 is a fixed member secured to the substrate 900.

When power is applied to the third coil 720, the second lens module 220 may be moved in the second optical axis (Z-axis) direction by electromagnetic force between the third driving magnet 710 and the third coil 720.

A third ball member B3 is disposed between the second lens module 220 and the housing 100, and the second lens module 220 may be guided by the third ball member B3 to move in the second optical axis (Z-axis) direction. The third ball member B3 includes a plurality of balls.

A third pulling magnet 730 may be disposed on a lower surface of the second lens module 220, and a third pulling yoke may be disposed on an internal bottom surface of the housing 100. The third pulling yoke may be formed of a magnetic material.

The third pulling magnet 730 may be disposed closer to one side of the second lens module 220. That is, the third pulling magnet 730 may be disposed closer to one side of the second lens module 220 than to the other side of the second lens module 220. Additionally, the third pulling magnet 730 may be disposed between one side of the second lens module 220 and the second optical axis (Z-axis).

The third pulling magnet 730 and the third pulling yoke may be disposed to face each other in the first optical axis (Y-axis) direction.

The third pulling magnet 730 and the third pulling yoke may generate an attractive force between each other. For example, the attractive force acts between the third pulling magnet 730 and the third pulling yoke in the first optical axis (Y-axis) direction.

The attractive force between the third pulling magnet 730 and the third pulling yoke allows the third ball member B3 to be in contact with the second lens module 220 and the housing 100, respectively.

Some of the plurality of balls of the third ball member B3 may be disposed close to a first side surface of the second lens module 220, and the other balls of the third ball member B3 may be disposed close to a second side surface of the second lens module 220. The number of balls disposed between the first side surface of the second lens module 220 and the second optical axis (Z-axis) may be greater than the number of balls disposed between the second side surface of the second lens module 220 and the second optical axis (Z-axis).

In an example embodiment, the third ball member B3 may include at least three balls. When the three balls are disposed, two balls of the three balls may be disposed between the first side surface of the second lens module 220 and the second optical axis (Z-axis), and the one ball of the three balls may be disposed between the second side surface of the second lens module 220 and the second optical axis (Z-axis).

The two balls disposed between first side surface of the second lens module 220 and the second optical axis (Z-axis) may be spaced apart from each other in the second optical axis (Z-axis) direction.

A fifth guide groove g5 and a sixth guide groove g6 may be disposed on at least one of surfaces on which the second lens module 220 and the housing 100 face each other. For example, the fifth guide groove g5 may be disposed on a first side of the lower surface of the second lens module 220, and the sixth guide groove g6 may be disposed on a second side of the lower surface of the second lens module 220.

The fifth guide groove g5 and the sixth guide groove g6 may be spaced apart from each other in a direction, perpendicular to the second optical axis (Z-axis) (e.g., in the first axis (X-axis) direction).

The fifth guide groove g5 and the sixth guide groove g6 extend in a direction, parallel to the second optical axis (Z-axis).

Some of the plurality of balls of the third ball member B3 may be disposed in the fifth guide groove g5, and the others of the plurality of balls of the third ball member B3 may be disposed in the sixth guide groove g6.

The number of contact points between some of the plurality of balls of the third ball member B3 and the fifth guide groove g5 may be greater than the number of contact points between the others of the plurality of balls of the third ball member B3 and the sixth guide groove g6.

The fifth guide groove g5 is disposed closer to one side surface of the second lens module 220 than to the sixth guide groove g6.

The third pulling magnet 730 may be disposed closer to the fifth guide groove g5 than to the sixth guide groove g6.

In an example embodiment, the camera module 1 may detect a position of the second lens module 220. To this end, a second position sensor 740 is provided. The second position sensor 740 may be disposed in a position facing the second driving magnet 710 of the second driver 700 (e.g., a position facing the first axis (X-axis) direction).

Accordingly, when the second lens module 220 moves in the second optical axis (Z-axis) direction, the position of the second lens module 220 may be detected through the second position sensor 740.

The second position sensor 740 may be a Hall sensor or a TMR sensor, as only examples.

In an example, Referring to FIG. 21, the second lens module 220 may further include a light shield plate 223. The light shield plate 223 may be coupled to the second lens module 220.

A first side surface and a second side surface of the second lens module 220 may extend from the second lens module 220 in the second optical axis (Z-axis) direction, respectively. A portion of a first side surface of the second lens module 220 and a portion of the second side surface of the second lens module 220 may face each other in the first axis (X-axis) direction. A space may be formed between a portion of the first side surface of the second lens module 220 and a portion of the second side surface of the second lens module 220.

The light shielding plate 223 may be disposed in a space between a portion of the first side surface of the second lens module 220 and a portion of the second side surface of the second lens module 220.

The light shielding plate 223 prevents light passing through the second lens module 220 from causing an unintentional reflection inside the housing 100. Accordingly, a flare phenomenon may be suppressed.

The camera module 1 may further include a third stopper 750. The third stopper 750 may be coupled to the housing 100 and may cover at least a portion of the second lens module 220.

In an example embodiment, the third stopper 750 may be disposed to face an upper surface of the second lens module 220 in the first optical axis (Y-axis) direction. A first side and a second side of the third stopper 750 may curvedly extend in the first optical axis (Y-axis) direction to face the second lens module 220 in the second optical axis (Z-axis) direction.

An elastic buffer member 751 may be coupled to the third stopper 750. For example, the buffer member 751 may be mounted on the first side and the second side of the third stopper 750 facing the second lens module 220 in the second optical axis (Z-axis) direction, respectively.

Additionally, a buffer member may be mounted on at least one of surfaces on which the third stopper 750 and the second lens module 220 face each other in the first optical axis (Y-axis) direction.

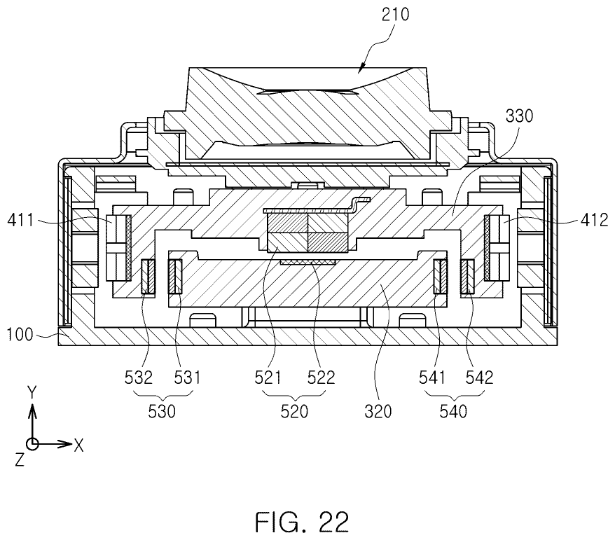

FIGS. 22 to 25 are views illustrating a modified example of the first and second magnetic components of a reflection module.

First, a reflection module of FIG. 22 differs from the example embodiment described with reference to FIGS. 1 to 14 with regard to the positions of the first and second magnetic components 530 and 540.

Referring to FIG. 22, the first and second magnetic components 530 and 540 may be spaced apart from each other in the first axis (X-axis) direction. The second pulling component 520 may be disposed between the first and second magnetic components 530 and 540. For example, the first and second magnetic components 530 and 540 may be spaced apart from each other in the first axis (X-axis) direction with respect to the second optical axis (Z-axis).

The first magnetic member 530 includes a first magnet 531 and a third magnet 532. The first magnet 531 and the third magnet 532 may face each other in the first axis (X-axis) direction.

The first magnet 531 may be disposed on one of the holder 330 and the guide member 320, and the third magnet 532 may be disposed on the other of the holder 330 and the guide member 320. In an example embodiment, the first magnet 531 is disposed on one external surface of the guide member 320, and the third magnet 532 is disposed on one internal surface of the holder 330.

Repulsive force acts between the first magnet 531 and the third magnet 532.

One surface of the first magnet 531 and one surface of the second magnet 532, which face each other in the first axis (X-axis) direction, may have the same polarity.

The second magnetic member 540 includes a second magnet 541 and a fourth magnet 542. The second magnet 541 and the fourth magnet 542 may face each other in the first axis (X-axis) direction.

The third magnet 541 may be disposed on one of the holder 330 and the guide member 320, and the fourth magnet 542 may be disposed on the other thereof. In an example embodiment, the second magnet 541 is disposed on the other external surface of the guide member 320, and the fourth magnet 542 is disposed on the other internal surface of the holder 330.

Repulsive force acts between the second magnet 541 and the fourth magnet 542.

One surface of the second magnet 541 and one surface of the fourth magnet 542, which face each other in the first axis (X-axis) direction, may have the same polarity.

A gap between the second pulling magnet 521 and the second pulling yoke 522 of the second pulling unit 520 may be narrower than a gap between the first magnet 531 and the third magnet 532 of the first magnetic member 530.

The gap between the second pulling magnet 521 and the second pulling yoke 522 of the second pulling unit 520 may be narrower than the gap between the second magnet 541 and the fourth magnet 542 of the second magnetic member 540.

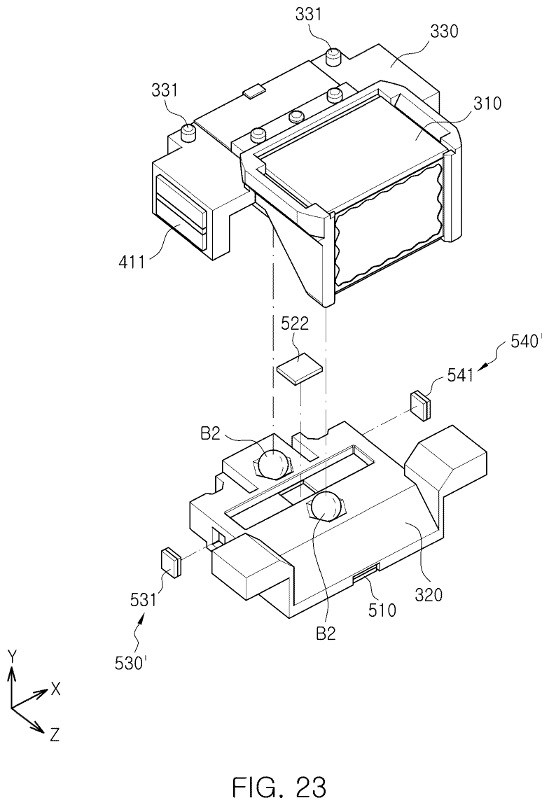

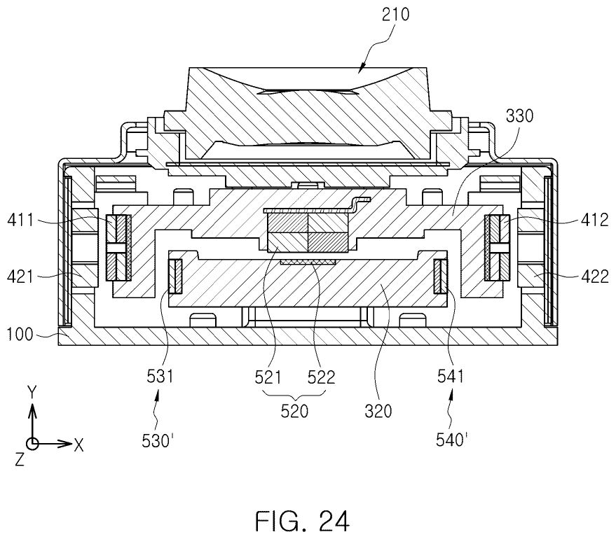

A reflection module of FIGS. 23 and 24 differs from the example embodiment described with reference to FIGS. 1 to 14 with regard to configurations and positions of a first magnetic member 530′ and a second magnetic member 540'.

Referring to FIGS. 23 and 24, the first magnetic member 530′ and the second magnetic member 540′ may be spaced apart from each other in the first axis (X-axis) direction. A second pulling unit 520 may be disposed between the first magnetic member 530′ and the second magnetic member 540′. For example, the first magnetic member 530′ and the second magnetic member 540′ may be spaced apart from each other in the first axis (X-axis) direction with respect to the second optical axis (Z-axis).

The first magnetic member 530′ may include a first magnet 531 disposed on the guide member 320. For example, the first magnet 531 may be disposed on one external surface of the guide member 320.

A first surface of the first magnet 531 may face the first driving magnet 411 disposed on a first side surface of the holder 330. For example, the first surface of the first magnet 531 may face the second surface of the first driving magnet 411 (e.g. a surface opposite to one surface facing the first coil 421) in the first axis (X-axis) direction.

A repulsive force may act between the first magnet 531 and the first driving magnet 411. In an example embodiment, a first surface of the first magnet 531 and a second surface of the first driving magnet 411 opposing each other may be configured to have the same polarity.

A first surface of the first driving magnet 411 faces the first coil 421 and has a first polarity and a second polarity spaced apart from each other in the first optical axis (Y-axis) direction. Additionally, a second surface of the first driving magnet 411 has a polarity opposite to that of the first surface of the first driving magnet 411.

Here, the first surface of the first magnet 531 is arranged to face one of the first polarity and the second polarity of the second surface of the first driving magnet 411 in the first axis (X-axis) direction.

For example, when the second surface of the first driving magnet 411 has an N-pole downwards in the first optical axis (Y-axis) direction and an S-pole upwards in the first optical axis (Y-axis) direction, the first surface of the first magnet 531 may face the N-pole of the first driving magnet 411. Since one side surface of the holder 330 on which the first driving magnet 411 is mounted may be disposed between the first magnet 531 and the first driving magnet 411, the one surface of the first magnet 531 may face the N-pole of the first driving magnet 411 with one side surface of the holder 330 interposed therebetween.

The first surface of the first magnet 531 has a single polarity, and one polarity of the first surface of the first magnet 531 is the same polarity as the polarity of the second surface of the first drive magnet 411 facing the first surface of the first magnet 531.

In the original position, an uppermost end (an end in the positive first optical axis (Y-axis) direction) of the first surface of the first magnet 531 may be disposed below an uppermost end (an end in the positive first optical axis (Y-axis) direction) of the polarity (e.g., the N-pole) of the second surface of the first drive magnet 411 facing the first surface of the first magnet 531.

The second magnetic member 540′ may include a second magnet 541 disposed on the guide member 320. For example, the second magnet 541 may be disposed on the other external surface of the guide member 320.

A first surface of the second magnet 541 may face the second drive magnet 412 disposed on the second side surface of the holder 330. For example, the first surface of the second magnet 541 may face the second surface of the second drive magnet 412 (e.g., a surface opposite to one surface facing the second coil 422) in the first axis (X-axis) direction.

A repulsive force may act between the second magnet 541 and the second drive magnet 412. In an example embodiment, the first surface of the second magnet 541 and the second surface of the second drive magnet 412 facing each other may be configured to have the same polarity.

A first surface of the second driving magnet 412 faces the second coil 422 and has a first polarity and a second polarity spaced apart from each other in the first optical axis (Y-axis) direction. The second surface of the second driving magnet 412 has a polarity opposite to that of one surface of the second driving magnet 412.

In an example, the first surface of the second magnet 541 is disposed to face one of the first and second polarities of the second surface of the second driving magnet 412 in the first axis (X-axis) direction.

For example, when the second surface of the second driving magnet 412 has an N-pole downwards in the first optical axis (Y-axis) direction and an S-pole upwards in the first optical axis (Y-axis) direction, the first surface of the second magnet 541 may face the N-pole of the second driving magnet 412. Since the second side surface of the holder 330 on which the second driving magnet 412 is mounted may be disposed between the second magnet 541 and the second driving magnet 412, the first surface of the second magnet 541 may face the N-pole of the second driving magnet 412 with one side surface of the holder 330 interposed therebetween.

The first surface of the second magnet 541 has a single polarity, and one polarity of the first surface of the second magnet 541 is the same polarity as the second surface of the second driving magnet 412 facing the first surface of the second magnet 541.

In the normal position, an uppermost end (e.g., an end in the positive first optical axis (Y-axis) direction) of the first surface of the second magnet 541 may be disposed below an uppermost end (the end in the direction of the positive first optical axis (Y-axis)) of the polarity (e.g., N-pole) of the second surface of the second driving magnet 412 facing the first surface of the second magnet 541.

A gap between the second pulling magnet 521 and the second pulling yoke 522 of the second pulling unit 520 may be narrower than a gap between the first magnetic member 530′ and the first driving magnet 411.

The gap between the second pulling magnet 521 and the second pulling yoke 522 of the second pulling unit 520 may be narrower than a gap between the second magnetic member 540′ and the second driving magnet 412.

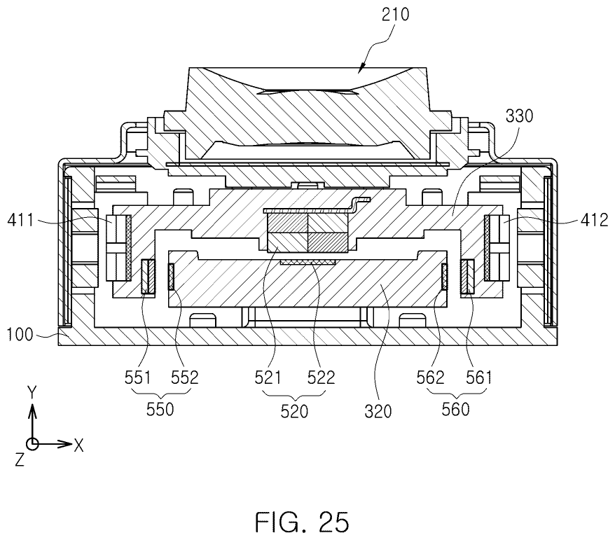

A reflection module of FIG. 25 differs from the example embodiment described with reference to FIGS. 1 to 14 in configurations and positions of a first magnetic member 550 and a second magnetic member 560.

Referring to FIG. 25, the first magnetic member 550 and the second magnetic member 560 may be spaced apart from each other in the first axis (X-axis) direction. A second pulling unit 520 may be disposed between the first magnetic member 550 and the second magnetic member 560. For example, the first magnetic member 550 and the second magnetic member 560 may be spaced apart from each other in the first axis (X-axis) direction with respect to the second optical axis (Z-axis).

The first magnetic member 550 includes a first magnet 551 and a first yoke 552. The first magnet 551 and the first yoke 552 may face each other in the first axis (X-axis) direction.

The first magnet 551 may be disposed on one of the holder 330 and the guide member 320, and the first yoke 552 may be arranged on the other. In an example embodiment, the first magnet 551 is disposed on an internal surface of the holder 330, and the first yoke 552 is disposed on an external surface of the guide member 320.

An attractive force acts between the first magnet 551 and the first yoke 552.

The second magnetic member 560 includes a second magnet 561 and a second yoke 562. The second magnet 561 and the second yoke 562 may face each other in the first axis (X-axis) direction.

The second magnet 561 may be disposed on one of the holder 330 and the guide member 320, and the second yoke 562 may be disposed on the other thereof. In an example embodiment, the second magnet 561 is disposed on the other internal surface of the holder 330, and the second yoke 562 is disposed on the other external surface of the guide member 320.

An attractive force acts between the second magnet 561 and the second yoke 562.

A gap between the second pulling magnet 521 of the second pulling unit 520 and the second pulling yoke 522 may be narrower than a gap between the first magnet 551 and the second magnet 552 of the first magnetic member 550.

A gap between the second pulling magnet 521 and the second pulling yoke 522 of the second pulling unit 520 may be narrower than a gap between the third magnet 561 and the fourth magnet 562 of the second magnetic member 560.

The attractive force acting between the first magnet 551 and the first yoke 552 and the attractive force acting between the second magnet 561 and the second yoke 562 may be balanced, thereby allowing the holder 330 to return to an original position thereof when no power is applied to the reflection module 300.

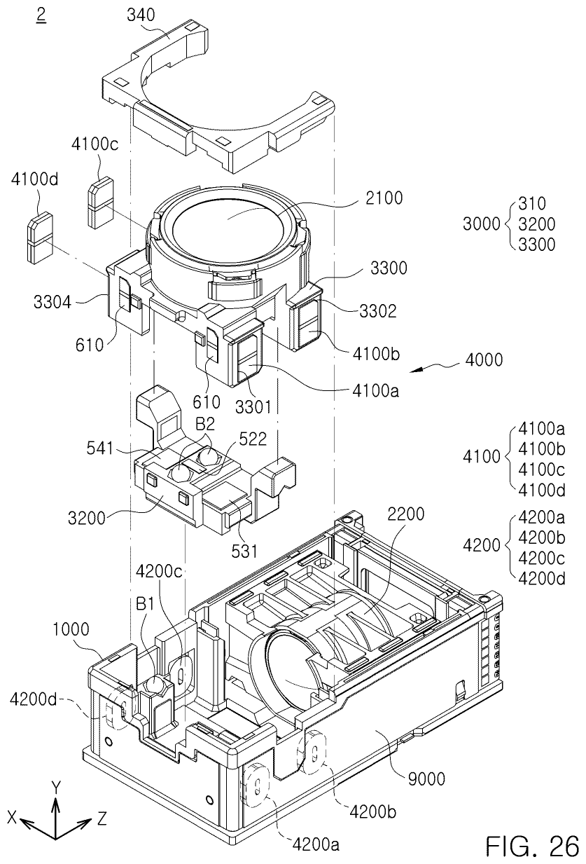

FIG. 26 is an exploded perspective view of an example camera module, in accordance with one or more embodiments.

Referring to FIG. 26, an example camera module 2, in accordance with one or more embodiments includes a reflection module 3000 and a housing 1000, and may further include a first lens module 2100.

An example embodiment of FIG. 26 differs from the previously described example embodiment in a configuration of a first driver 4000.

The first lens module 2100 may be coupled to the reflection module 3000. For example, the first lens module 2100 may be coupled to a holder 3300 of the reflection module 3000.

In an example embodiment, the camera module 2 may further include a second lens module 2200. The reflection module 3000 is disposed between the first lens module 2100 and the second lens module 2200.

A first optical axis (Y-axis) of the first lens module 2100 and a second optical axis (Z-axis) of the second lens module 2200 may be formed to be perpendicular to each other.

The first lens module 2100 includes one or more lenses, and the second lens module 2200 includes multiple lenses.

The first lens module 2100 and the reflection module 3000 may be configured to rotate together for the purpose of performing shake correction. The second lens module 2200 may be moved in the second optical axis (Z-axis) direction for the purpose of performing focus adjustment.

The reflection module 3000 includes the reflection member 310 (FIG. 4), the holder 3300 and a guide member 3200.

The reflection member 310 has a reflection surface that reflects light passing through the first lens module 2100. As an example, the reflection member 310 may be a prism or a mirror.

The reflection member 310 is mounted on the holder 3300. The first lens module 2100 may be disposed in front of the reflection member 310. In an example embodiment, the first lens module 2100 may be mounted on the holder 3300.

The holder 3300 is rotatably disposed on the guide member 3200. Additionally, the guide member 3200 is rotatably disposed on the housing 1000.

The guide member 3200 may be rotated about a first axis (X-axis), perpendicular to both the first optical axis (Y-axis) and the second optical axis (Z-axis), as the rotation axis. As an example, the guide member 3200 may be relatively rotatable on the housing 1000 about the first axis (X-axis) as the rotation axis. In this example, the first lens module 2100 and the holder 3300 may also rotate together with the guide member 3200. In an example, the first axis (X-axis) may also be referred to as a first rotation axis.

The holder 3300 may rotate about a second optical axis (Z-axis), perpendicular to the first axis (X-axis), as the rotation axis. For example, the holder 3300 may be rotatably rotated on the guide member 3200 about the second optical axis (Z-axis) as the rotation axis. In this example, the first lens module 2100 may rotate together with the holder 3300. In an example, the second optical axis (Z-axis) may also be referred to as a second rotation axis.

The first driver 4000 may be provided to rotate the reflection module 3000. The first driver 4000 includes a driving magnet unit 4100 and a coil unit 4200.

The first driver 4000 may allow the guide member 3200 to be relatively rotated on the housing 1000 around the first axis (X-axis). Since the holder 3300 and the first lens module 2100 are disposed on the guide member 3200, the holder 3300 and the first lens module 2100 may also rotate together with the guide member 3200.

The first driver 4000 may allow the holder 3300 to be relatively rotated on the guide member 3200 around the second optical axis (Z-axis). Since the first lens module 2100 is disposed in the holder 3300, the first lens module 2100 may also rotate together with the holder 3300.

The driving magnet unit 4100 may be mounted on the holder 3300. In an example, the driving magnet unit 4100 may be mounted on the side surface of the holder 3300.

The driving magnet unit 4100 includes a plurality of magnets. For example, the driving magnet unit 4100 may include a first driving magnet 4100a, a second driving magnet 4100b, a third driving magnet 4100c, and a fourth driving magnet 4100d.

The holder 3300 includes a first side surface 3301, a second side surface 3302, a third side surface and a fourth side surface 3304. The first side surface 3301 and the second side surface 3302 may be surfaces that are disposed on a first side of the holder 3300 based on the second optical axis (Z-axis), and the third side surface and the fourth side surface 3304 may be surfaces that are disposed on a second side of the holder 3300 based on the second optical axis (Z-axis).

The first side surface 3301 and the second side surface 3302 are spaced apart from each other in the second optical axis (Z-axis) direction, and the third side surface and the fourth side surface 3304 are spaced apart from each other in the second optical axis (Z-axis) direction.

Additionally, the first side surface 3301 and the fourth side surface 3304 are spaced apart from each other in the first axis (X-axis) direction, and the second side surface 3302 and the third side surface are spaced apart from each other in the first axis (X-axis) direction.

The first driving magnet 4100a may be disposed on the first side surface 3301 of the holder 3300, the second driving magnet 4100b may be disposed on the second side surface 3302 of the holder 3300, the third driving magnet 4100c may be disposed on the third side surface of the holder 3300, and the fourth driving magnet may be disposed on the fourth side surface 3304 of the holder 3300.

The first ball member B1 may be disposed between the first side surface 3301 and the second side surface 3302 of the holder 3300, and between the third side and the fourth side surface 3304.

The coil unit 4200 includes a plurality of coils. For example, the coil unit 4200 may include a first coil 4200a facing the first driving magnet 4100a, a second coil 4200b facing the second driving magnet 4100b, a third coil 4200c facing the third driving magnet 4100c, and a fourth coil 4200d facing the fourth driving magnet 4100d.

In an example, the coil unit 4200 may be disposed on a substrate 9000.

When power is applied to the first driver 4000, the first driver 4000 may generate a driving force necessary for a rotation about the first axis (X-axis) of the holder 3300 and the guide member 3200 as the rotation axis, and a driving force necessary for a rotation about the second optical axis (Z-axis) of the holder 3300. For example, the first driver 4000 may rotate the holder 3300 and the guide member 3200 by adjusting the driving force of four pairs of magnets and coils.

In an example embodiment, among the four pairs of magnets and coils, directions of the driving forces of the magnets and the coils spaced apart from each other in the diagonal direction may be opposite to each other. For example, the first coil 4200a and the third coil 4200c may be connected in series. Accordingly, a direction of a driving force between the first driving magnet 4100a and the first coil 4200a, and a direction of a driving force between the third driving magnet 4100c and the third coil 4200c may be formed to be opposite to each other.

However, the coils disposed in the diagonal direction do not necessarily have to be connected in series, and may also be controlled individually.

When a direction of a driving force generated by the first driving magnet 4100a and the first coil 4200a is the positive first optical axis (Y-axis) direction (+Y-axis direction), a direction of a driving force generated by the third driving magnet 4100c and the third coil 4200c disposed in the diagonal direction may be the negative first optical axis (Y-axis) direction (−Y-axis direction).

When a direction of a driving force generated by the second driving magnet 4100b and the second coil 4200b is the negative first optical axis (Y-axis) direction (−Y-axis direction), a direction of a driving force generated by the fourth driving magnet 4100d and the fourth coil 4200d disposed in the diagonal direction may be the positive first optical axis (Y-axis) direction (+Y-axis direction).

Accordingly, when a direction of a driving force of the first driving magnet 4100a and the first coil 4200a, and a direction of a driving force of the fourth driving magnet 4100d and the fourth coil 4200d are the same (e.g., the positive first optical axis (Y-axis) direction (+Y-axis direction)), and when a direction of a driving force of the second driving magnet 4100b and the second coil 4200b, and a direction of a driving force of the third driving magnet 4100c and the third coil 4200c are the same (e.g., the negative first optical axis (Y-axis) direction (−Y-axis direction)), the holder 3300 and the guide member 3200 may be rotated based on the first axis (X-axis).

When the direction of the driving force of the first driving magnet 4100a and the first coil 4200a, and the direction of the driving force of the second driving magnet 4100b and the second coil 4200b are the same (e.g., the positive first optical axis (Y-axis) direction (+Y-axis direction)), and when the direction of the driving force of the third driving magnet 4100c and the third coil 4200c, and the direction of the driving force of the fourth driving magnet 4100d and the fourth coil 4200d are the same (e.g., the negative first optical axis (Y-axis) direction (−Y-axis direction)), the holder 3300 may be rotated based on the first axis (X-axis).

Additionally, the holder 3300 may also be rotated in the diagonal direction by controlling the power applied to the first coil 4200a and the third coil 4200c, and the power applied to the second coil 4200b and the fourth coil 4200d.

For example, when power is applied to the first coil 4200a and the third coil 4200c, and power is not applied to the second coil 4200b and the fourth coil 4200d, the holder 3300 may be rotated in the diagonal direction.

A position sensing method of the holder 3300 and the guide member 3200 is the same as in the previously described example embodiment, and thus, a detailed description thereof will be omitted.

While this disclosure includes specific examples, it will be apparent after an understanding of the disclosure of this application that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner, and/or replaced or supplemented by other components or their equivalents.

Therefore, in addition to the above and all drawing disclosures, the scope of the disclosure is also inclusive of the claims and their equivalents, i.e., all variations within the scope of the claims and their equivalents are to be construed as being included in the disclosure.

What is claimed is:

1. A reflection module, comprising:
a housing;
a guide member configured to rotate relative to the housing, based on a first rotation axis;
a holder, configured to rotate relative to the guide member based on a second rotation axis, and having a reflection member mounted thereon;
a first pulling member disposed between the guide member and the holder; and
a first magnetic member and a second magnetic member spaced apart from each other in a direction of the first rotation axis, with the first pulling member interposed between the first magnetic member and the second magnetic member,
wherein the first magnetic member comprises a first magnet disposed on the guide member, and
wherein the second magnetic member comprises a second magnet disposed on the guide member.

2. The reflection module according to claim 1, wherein the first pulling member comprises a first pulling magnet disposed in one of the guide member and the holder and a first pulling yoke disposed in another of the guide member and the holder, and
the first pulling magnet and the first pulling yoke face each other in a direction, perpendicular to both the first rotation axis and the second rotation axis.

3. The reflection module according to claim 1, wherein one surface of the first magnet and one surface of the second magnet, which are exposed to an external surface of the guide member, each have a single polarity.

4. The reflection module according to claim 1, wherein the first magnetic member further comprises a third magnet disposed on the holder, and
the second magnetic member comprises a fourth magnet disposed on the holder.

5. The reflection module according to claim 4, wherein surfaces on which the first magnet and the third magnet face each other have a same polarity, and
surfaces on which the second magnet and the fourth magnet face each other have a same polarity.

6. The reflection module according to claim 4, wherein a direction of a magnetic force of the first pulling member and a direction of a magnetic force of the first magnetic member are opposite to each other, and
a direction of a magnetic force of the first pulling member and a direction of a magnetic force of the second magnetic member are opposite to each other.

7. The reflection module according to claim 1, wherein a first ball member is disposed between the guide member and the holder, and
the first ball member comprises a plurality of balls spaced apart from each other in a direction of the second rotation axis.

8. The reflection module according to claim 7, wherein the first pulling member is disposed between the plurality of balls.

9. The reflection module according to claim 1, wherein the second rotation axis is disposed between the first magnetic member and the second magnetic member.

10. The reflection module according to claim 1, further comprising:
a first diver comprising a driving magnet unit disposed in the holder and a coil unit that faces the driving magnet unit,
wherein the driving magnet unit comprises a first driving magnet and a second driving magnet that are spaced apart from each other in the direction of the first rotation axis.

11. The reflection module according to claim 10, wherein a first ball member is disposed between the guide member and the holder, and the first ball member comprises a plurality of balls that are spaced apart from each other in a direction of the second rotation axis,
wherein a second ball member is disposed between the guide member and the housing, and the second ball member comprises a plurality of balls that are spaced apart from each other in the direction of the first rotation axis,
wherein the first driver is spaced apart from the second ball member in the direction of the second rotation axis, and
wherein the first driver is spaced apart from the first ball member in the direction of the first rotation axis.

12. The reflection module according to claim 10, further comprising:
a position sensing unit comprising a plurality of first position sensors disposed in the housing,
wherein the plurality of first position sensors are spaced apart from each other in the direction of the first rotation axis.

13. The reflection module according to claim 12, wherein the position sensing unit further comprises a plurality of sensing magnets disposed on the holder, and the plurality of sensing magnets are spaced apart from each other in the direction of the first rotation axis.

14. The reflection module according to claim 12, wherein the position sensing unit is configured to:
generate a first position signal of the holder by summing signal values output from the plurality of first position sensors, and
generate a second position signal of the holder by calculating a difference between signal values output from the plurality of first position sensors,
wherein the first position signal is a position signal of one of a rotation of the holder based on the first rotation axis and a rotation of the holder based on the second rotation axis, and
wherein the second position signal is a position signal of another of a rotation of the holder based on the first rotation axis and a rotation of the holder based on the second rotation axis.

15. The reflection module according to claim 1, further comprising:
a first lens module having a first optical axis and coupled to the holder,
wherein the first rotation axis and the second rotation axis are perpendicular to each other, and
wherein the first optical axis is perpendicular to both the first rotation axis and the second rotation axis.

16. A camera module, comprising:
a housing;
a guide member configured to rotate relative to the housing based on a first rotation axis;
a holder, configured to rotate relative to the guide member based on a second rotation axis, and having a reflection member mounted thereon;
a first magnetic member and a second magnetic member spaced apart from each other in a direction of the first rotation axis;
a first driver comprising a driving magnet unit disposed in the holder and a coil unit that faces the driving magnet unit;
a first ball member disposed between the guide member and the holder, and comprising a plurality of balls spaced apart from each other in a direction of the second rotation axis; and
a second ball member disposed between the guide member and the housing, and including a plurality of balls spaced apart from each other in the direction of the first rotation axis,
wherein the driving magnet unit comprises a first driving magnet and a second driving magnet spaced apart from each other in the direction of the first rotation axis,
wherein the first magnetic member comprises a first magnet disposed in the guide member,
wherein the second magnetic member comprises a second magnet disposed on the guide member, and
wherein a first ball member is disposed between the first magnet and the second magnet.

17. The camera module according to claim 16, further comprising:
a first pulling member disposed between the guide member and the holder,
wherein the first pulling member is disposed between the plurality of balls of the first ball member.

18. The camera module according to claim 17, wherein the first pulling member comprises a first pulling magnet disposed in one of the guide member and the holder, and a first pulling yoke disposed in another of the guide member and the holder,
wherein one surface of the first pulling magnet facing the first pulling yoke has a plurality of polarities, and
wherein one surface of the first magnet and one surface of the second magnet facing the holder each have a single polarity.

19. The camera module according to claim 18, wherein a gap between the first pulling magnet and the first pulling yoke is narrower than a gap between the first magnet and the holder, and narrower than a gap between the second magnet and the holder.

20. The camera module according to claim 16, wherein the coil unit comprises a first coil that faces a first surface of the first driving magnet and a second coil that faces a first surface of the second driving magnet,
wherein each of the first surface of the first driving magnet and the first surface of the second driving magnet is polarized to have different polarities in directions perpendicular to both the first rotation axis and the second rotation axis,
wherein a second surface of the first driving magnet has a polarity opposite to the first surface of the first driving magnet, and a second surface of the second driving magnet has a polarity opposite to the first surface of the second driving magnet,
wherein a first surface of the first magnet has a same polarity as one of polarities of a second surface of the first driving magnet, and
wherein a first surface of the second magnet has a same polarity as one of polarities of a second surface of the second driving magnet.
